(19) United States
(12) Patent Application Publication
(10) Pub. No.: US 2013/0258904 A1
(43) Pub. Date: Oct. 3, 2013

(54) CONFIGURABLE WIRELESS NETWORKS, SYSTEMS AND METHODS

(71) Applicant: Yaron KAUFMANN, Tel-Aviv (IL)

(72) Inventor: Yaron KAUFMANN, Tel-Aviv (IL)

(73) Assignee: CARTASENSE LTD., Petah Tikva (IL)

(21) Appl. No.: 13/532,868

(22) Filed: Jun. 26, 2012

Related U.S. Application Data
(63) Continuation-in-part of application No. 13/376,843, filed on Mar. 28, 2012.

(51) Int. Cl. H04W 84/20

(52) U.S. Cl. 370/255

(57) ABSTRACT

According to an embodiment of the invention there is provided a wireless network that may include a wireless network leader and multiple wireless units; wherein each wireless unit has a single father wireless unit, wherein the father wireless unit is selected out of the wireless network leader and the multiple wireless units; wherein each wireless unit may be arranged to be configured according to a wireless unit configuration selected out of: (a) an unauthorized and empty wireless unit, (b) an authorized and full wireless unit, (c) an authorized and not full wireless unit, and (d) an unauthorized and not empty wireless unit; wherein each wireless unit may be arranged to transmit messages only to a father of the wireless unit or to a son of the wireless unit.

### RELATED APPLICATIONS

This patent application is a continuation in part of U.S. patent application Ser. No. 13/376,843 which in turn is a continuation in part of PCT patent application publication serial number WO 2010143182, titled “WIRELESS NETWORKS SYSTEMS AND METHODS” which claims priority from U.S. provisional patent Ser. No. 61/185,206 filing date Jun. 9, 2009, from U.S. provisional patent Ser. No. 61/226,754 filing date Jul. 20, 2009 and from U.S. provisional patent Ser. No. 61/255,864 filing date Oct. 19, 2009, all patent applications being incorporated herein in their entirety.

### BACKGROUND OF THE INVENTION

Goods—and among which goods that need to be environmental or otherwise controlled—are conveyed and stored before being sold to the end user. During the conveying and the storage these goods can be damaged. There is a growing need to provide systems and methods for cost effective and reliable monitoring of goods.

### SUMMARY OF THE INVENTION

According to an embodiment of the invention there is provided a wireless network that may include a wireless network leader and multiple wireless units; wherein each wireless unit has a single father wireless unit, wherein the father wireless unit is selected out of the wireless network leader and the multiple wireless units; wherein each wireless unit may be arranged to be configured according to a wireless unit configuration selected out of a group consisting of: (a) an unauthorized and empty wireless unit that has no sons and is not authorized to have sons, (b) an authorized and full wireless unit that is connected to a maximal allowable number of sons, (c) an authorized and not full wireless unit that has less than the maximal allowable number of sons and is authorized to add at least one son, and (d) an unauthorized and not empty wireless unit that has less than the maximal allowable number of sons and is unauthorized to add at least one son; wherein each wireless unit may be arranged to transmit messages only to a father of the wireless unit or to a son of the wireless unit; wherein a configuration triggering unit of the wireless network may be arranged to trigger a change of at least one wireless unit configuration. The configuration triggering unit may be the wireless network leader or any other wireless unit. The identity of the configuration triggering unit can change over time or remain constant.

The configuration triggering unit may be the wireless network leader.

The configuration triggering unit may be a father wireless unit that may be arranged to trigger a change of a wireless unit configuration of at least one his sons.

The configuration triggering unit may be a wireless unit that may be arranged to trigger a change of its own configuration.

The configuration triggering unit may be arranged to trigger the change of at least one wireless unit configuration if it is determined that a number of levels of the wireless network exceeds a first threshold.

The configuration triggering unit may be arranged to trigger the change of at least one wireless unit configuration if it is determined that a current topology of the network is unbalanced by an unbalance factor that exceeds a second threshold.

The configuration triggering unit may be arranged to trigger the change of at least one wireless unit configuration if it is determined that a change in a number of wireless units that belong to the wireless network exceeds a third threshold.

The configuration triggering unit may be arranged to trigger the change of at least one wireless unit configuration if it is determined that a change in a number of wireless units that belong to the wireless network exceeds a third threshold.

The configuration triggering unit may be arranged to trigger the change of at least one wireless unit configuration of a wireless unit if it is determined that a value of a communication parameter deviates from a desired value, wherein the communication parameter relates to a communication between the wireless unit and either a son of the wireless unit or a father of the wireless unit.

The configuration triggering unit may be arranged to trigger the change of at least one wireless unit configuration of a wireless unit if it is determined that a value of a power consumption of at least one wireless unit deviates from a desired value.

Each father may be arranged to allocate, for each son, a son identifier that represents the order of associating each one of the son, father and at least zero higher-hierarchy wireless unit.

A plurality of wireless units and at least one father may be a sensor or may include a sensor.

According to an embodiment of the invention there is provided a method for operating a wireless network, the wireless network comprises a wireless network leader and multiple wireless units. The method may include: (i) configuring, at a first point in time, the wireless units, so that each wireless is configured to according to a wireless unit configuration selected out of a group consisting of: (a) an unauthorized and empty wireless unit that has no sons and is not authorized to have sons, (b) an authorized and full wireless unit that is connected to a maximal allowable number of sons, (c) an authorized and not full wireless unit that has less than the maximal allowable number of sons and is authorized to add at least one son, and (d) an unauthorized and not empty wireless unit that has less than the maximal allowable number of sons and is unauthorized to add at least one son; (ii) transmitting, by at least one wireless unit messages only to a father of the wireless unit or to a son of the wireless unit; wherein each wireless unit has a single father wireless unit, wherein the father wireless unit is selected out of the wireless network leader and the multiple wireless units; and (iii) triggering, by a configuration triggering unit of the wireless network and at a second point in time, a change of at least one wireless unit configuration; wherein the configuration triggering unit is selected out of the wireless network leader and the multiple wireless units.

The method may include allowing a wireless unit to find one or more sons if it is authorized to do so and only after a father of that wireless unit is defined.

The method may include allowing wireless units to find sons in a gradual manner.

The method may include allowing, during a first time window, the wireless network leader to find first level wireless units and define the first level wireless unit as sons; and allowing, during a second time window authorized and non-full first level wireless units to find second level wireless units and define the second level wireless units as sons.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a wireless network according to an embodiment of the invention;

FIG. 2 illustrates a first wireless unit, according to an embodiment of the invention;

FIG. 3 illustrates a method for wireless communication, according to an embodiment of the invention;

FIG. 4 illustrates a low complexity wireless network, according to an embodiment of the invention;

FIG. 5 illustrates a method for operating a low complexity wireless network, according to an embodiment of the invention;

FIG. 6 illustrates a wireless unit, according to an embodiment of the invention;

FIG. 7 illustrates a method for fast network detection in a wireless network, according to an embodiment of the invention;

FIG. 8 illustrates an application of the herd network in a truck and trailer configuration, according to an embodiment of the invention;

FIG. 9 illustrates an application of the herd network in a warehouse, cooling, or ship type configuration, according to an embodiment of the invention;

FIG. 10 illustrates a herd wireless network, according to an embodiment of the invention;

FIG. 11 illustrates a wireless unit, according to an embodiment of the invention;

FIGS. 12-14 are flow charts of methods according to various embodiments of the invention;

FIG. 15 illustrates a method according to an embodiment of the invention; and

FIG. 16 illustrates a wireless network according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous—though not necessarily identical—elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The following description is presented to enable one of ordinary skill in the art to make and use the invention as provided in the context of a particular application and its requirements.

Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

The phrase “herd network” as used herein may encompass a variety of network topologies that include multiple wireless sensors enabled to communicate in a high attenuation environment, for example, in a warehouse, shipyard, or refrigeration environment where multiple stacks of containers, pallets, boxes etc. are present. The herd network is designed to keep the nodes complexity (and thus the cost) very low, and require ultra low power consumption to operate. In order to allow for reliable delivery of data in a challenging communication environment, for example in fresh produce warehouses, refrigerators etc, where there are high attenuation levels of the electromagnetic transmissions, using low transmission power, a multi-hop, star or mixed network topologies (a.k.a. mesh) can be used, to create a herd network which is a time synchronized network with a very low duty cycle.

According to some embodiments challenging communication environments include agricultural fields, livestock fields and environments, mines, grains and/or minerals silos, high traffic areas etc. Furthermore, the systems and methods disclosed may be implemented for: product storage monitoring, smart irrigation control, monitoring for dangerous gases, transportation of mineral and chemicals, etc According to some embodiments the sensors include soil moisture sensors, chemicals humidity sensor, sound sensors, and electrical continuity sensors. According to some embodiments the sensors can be located in different structures such as structures known as pallets, within products packed or placed in containers or boxes, distributed in the field or buried in chemicals etc,

According to some embodiments the herd networks and/or the wireless networks disclosed below are TDMA networks (or variants thereof), where connectivity is achieved through “channels” which are specific slots in time, that may be common to two members, or typically, a member (also referred to as “wireless unit” and “low-power wireless unit”) and a leader (also referred to as “wireless network leader”). When these two or more wireless network components (e.g. members, member and leader) are sharing the same time slot, information exchange is possible. According to some embodiments the herd networks and/or the wireless networks disclosed are TDMA networks (or variants thereof), where connectivity is achieved through “channels”. When two or more wireless network components (e.g. members, member and leader) are sharing the same time slot, in some case only partially, information exchange is possible.

According to an embodiment of the invention, the wireless network leader may be generally active (in mobile configurations the wireless network leader may operate in low duty cycle and open its receiver only in its allocated time slots); the members are active only during the time slots which are assigned to the channels. The wireless networks and -wireless network topologies disclosed below (e.g. the herd networks) may be used to effectively assign and maintain valid channels between all the network members.

In some embodiments of the wireless networks disclosed, the root node (i.e. the wireless network leader) may have no control over the network topology. That is, wireless units of the wireless network may have autonomy to accept new members into the network without receiving any instructions from the wireless network leader. The topology may be set by very simple rules of each wireless unit node, e.g. according to chance configuration and the relative location of the nodes. That is—a new member may be accepted into the network structure in a location that is determined by relative location (e.g. joining one of the closest wireless units of the network—with which the new member may have connection), and by chance (e.g. which of this nearby units was the first to indicate its existence to non-member wireless units). Such simple set up is effective in achieving stable and reliable wireless mesh network.

Some of the systems and methods disclosed below may be implemented for product storage monitoring. The wireless networks and systems disclosed below includes a wireless network leader (also referred to as control unit) and a multitude of wireless units that form a wireless network. For example, such systems may be used for enabling real time storage monitoring, using: i. disposable smart and active RFID tags (that support a variety of sensors) for the low-power wireless units (other alternatives may be, for example, Wireless Sensors Network (WSN)—or other wireless tags); ii. a control unit (that may be a wireless network leader) with a network interface (e.g. Communications Unit (CU)/reader/router/hub/aggregator); and iii. a communications server that is connected to the control unit and receives from it information, and which is used as a management system.

Such system may be managed by a basic Web based management application. The wireless tags may integrate different sensors (internal and/or external), battery, micro controller, non-volatile memory and a RF circuit. In some implementations, the communication between the tags and the router/reader may be conducted through a leader node and/or through other tags, establishing an ad hoc, robust, dynamic WSN (Wireless Sensor Network), where various wireless tags serve as store and forward (S&F) networking devices.

According to an embodiment of the invention, the ad hoc WSN is built and maintained automatically by the tags (it is noted that tags may be replaced with other wireless units, and especially with low-power wireless units, e.g. as disclosed below). The control unit (the leader) is not required to be in range with all the tags, yet it can communicate with every tag by using other tags as links. In this way, the monitored objects (for example food packages,) can be piled up in different structures (e.g. the structures known as pallets), quantity of readers will be able to achieve 100% coverage of the tags.

In one example, typical communication link attenuation between two wireless sensors, placed arbitrarily inside pallets loaded with fresh produce, can be more than 100 dB. The sensors are placed, for example, in the fresh produces or product packages (that may also referred to as boxes). The boxes may be placed one on top of the other, in a pallet. In some embodiments there is one tag per pallet, such that when the pallets are moved through the cold chain (or other controlled transportation environment), from the packing house to the retailer shelves, the sensors are able to establish a wireless network, thereby enabling communication of data between multiple tags and providing real-time and historical information about the quality of the environmental control of the fresh produce being delivered throughout the cold chain. In some embodiments there are multiple tags per pallet of other container unit. In some cases the tags are identical, in other cases that may differ, e.g. containing different sensors. In some embodiments, a network may communicate at every stop along the cold chain (or other transportation system) such as logistic support stations, truck stops, rest points etc. In another embodiment a network may communicate periodically and in some cases multiple times form the same location.

According to some embodiments the wireless networks disclosed may be TDMA networks, where connectivity is achieved through “channels” which are specific slots in time, common to two or more members, or a member and a leader. When these two or more members are sharing the same time slot, information exchange is possible. While the leader is active in a low duty cycle manner, with its receiver active only in its allocated time slots, the members are active only during the time slots which are assigned to the channels, thus achieving very low duty cycles and ultra low power consumption. The herd network is adapted to effectively assign and maintain valid channels between all the network members.

In some embodiments the network may stabilize on a certain topology based on the relative location of the nodes and the electromagnetic propagation between the nodes. This simple set up is effective in achieving stable and reliable wireless mesh network as is it is based on rigid time slot channel allocation, and is based on connections between nodes that are good enough for communication from the time the connection is established.

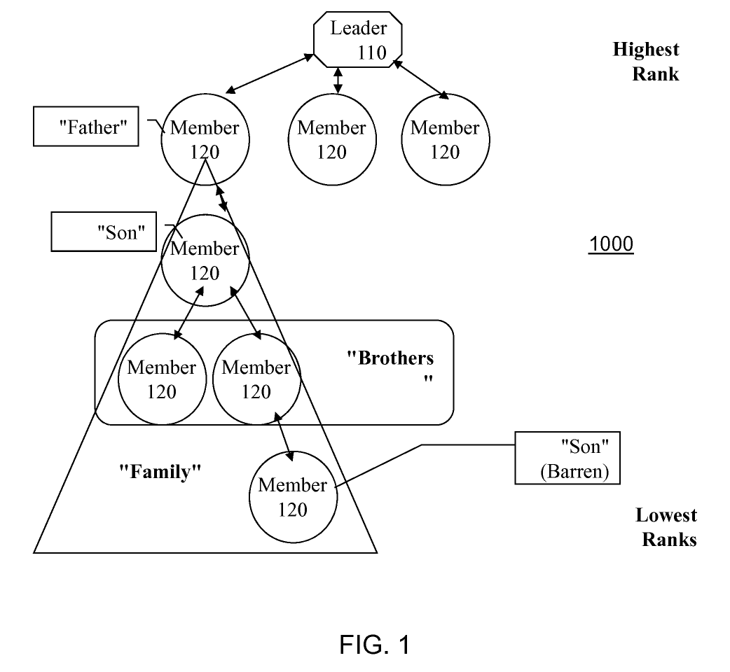

Reference is now made to FIG. 1, which illustrates a wireless network 1000 according to an embodiment of the invention. Such a wireless network is also referred to as a herd type network, based on herd “family” relationships. As can be seen in FIG. 1, the network 1000 is configured in ranks, where the leader 110 has the highest rank. According to an embodiment of the invention, the leader 110 may set the number of ranks in the network. According to an embodiment of the invention, each member 120 can have a maximum number of sons (e.g. 4, 16) and out of those sons, multiple sons (e.g. 1,) may have sons (i.e. these are non-barren). It is noted that the terms “child” and “son” are used interchangeably throughout the disclosure.

Each member 120 must have a father—such that each new member that joins the network must identify a potential father and perform a first registration process to that potential father member. It is noted that the leader may also look for a father, according to an embodiment of the invention (e.g. the leader may have a central warehouse management unit as a father). After a completion of the first registration process (e.g. when receiving an acknowledgment of registration from a potential father), the member is able to join the network. Some members 120 cannot have sons (i.e. childless, hereinafter referred to as “barren”). Lowest rank members (Rank 0, the number of ranks may be defined by the leader) are always barren. The leader 110, according to an embodiment of the invention, can have a maximum of 127 sons, where each father member 120 can have up to 4 sons, but only one of those sons can become a father to another unit. Other configurations may also be used.

The wireless network (e.g. herd network), according to some embodiments, supports a cluster tree topology, wherein the network has one root node (leader)) and all communication is routed to the leader. Member to member communication has one primary purpose: to relay data to the leader or from the leader. According to an embodiment of the invention, the network topology may be controlled by the leader (e.g. by ordering low-rank members to look for substitute fathers, by defining the number of allowed sons, and so forth). In some embodiments there are two (or more) predefined configurations—e.g. “flat” (that is where there are many sons directly connected to the leader, but few ranks allowed) and “narrow” (where there are few direct connections to the leader, but many ranks allowed), however other configurations may be defined, per the requirements of the installation.

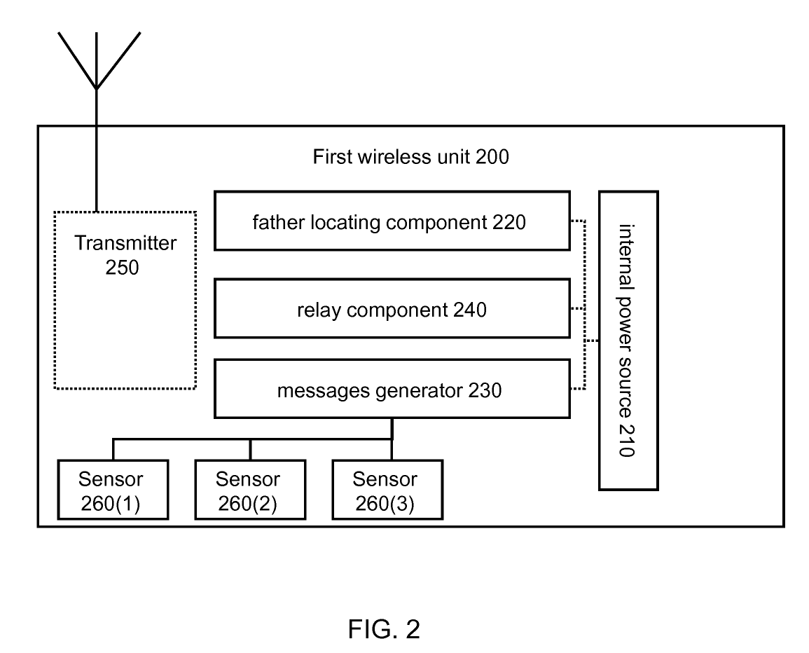

FIG. 2 illustrates a first wireless unit 200, according to an embodiment of the invention. It is noted that wireless unit 200 may serve as a wireless unit (or member) of the various system and networks disclosed.

First wireless unit 200 includes an internal power source 210, adapted to provide energy to at least some of the components of first wireless unit 200 for a long duration without recharge or power source replace (battery change), and especially to father finding component 220, messages generator 230, and relay component 240. It is noted that in different embodiments of the invention (and in different operation/usage scenarios), the internal power source 210 may be able to provide energy for different durations prior to being recharged (if implemented), e.g. a week, a month, 90 days, a year.

First wireless unit 200 includes a father finding component 220, adapted to find a second wireless unit (that is a member of a wireless network, and which may be substantially similar or identical to first wireless unit 200, but not necessarily so) that is configured to function as a father unit for the first wireless unit 200; to participate with the second wireless unit in a first registration process; and to cease looking for a father unit after a completion of the first registration process (e.g. after receiving from the father unit an acknowledgement of the registration). It is noted that in addition to finding, locating of a wireless unit may also be implemented in some embodiments of the invention.

First wireless unit 200 further includes messages generator 230, adapted to generate messages that include identification information of the first wireless unit 200, and a transmitter 250 that transmits the messages to the father unit at a small number of transmissions per hour and at a low power mode. It is noted that the messages may be generated routinely (e.g. every half an hour), and or in response to predefined conditions met (e.g. due to sensor information). According to an embodiment of the invention, messages may be generated routinely every 1 minute. According to an embodiment of the invention messages may be generated routinely every 10 minutes.

According to an embodiment of the invention messages may be generated routinely every 45 minutes. According to an embodiment of the invention, messages may be generated routinely every 1 hour.

According to an embodiment of the invention messages may be generated routinely every 10 hours. According to an embodiment of the invention messages may be generated routinely every 48 hours. In some embodiments, the messages are generated in response to predefined conditions met (e.g. due to sensor information, like a temperature excursion), and or at random or semi random timing. According to an embodiment of the invention messages are generated at a request or query from the father unit or from the root unit (leader).

It is noted that throughout the disclosure, the small number of transmissions per hour is lower (and usually substantially lower) than the large number of transmissions per hour used below. For example, the small number of transmissions per hour may be ten times smaller, or a hundred times smaller, than the large number of transmissions per hour. It is noted that the numbers of transmissions per hour used throughout this disclosures may have different meanings in different embodiments of the invention, such as (though not limited to) number of messages per hour, number of signals per hour, number of packets per hour, number of sessions per hour, etc. It is noted that the terms “small number of transmissions” and “low average rate of transmission” and “low number of transmissions” are used interchangeably throughout the disclosure. Similarly, the terms “large number of transmissions” and “high average rate of transmission” and “high number of transmissions” are used interchangeably throughout the disclosure.

First wireless unit 200 further includes relay component 240, adapted to participate with a child wireless unit in a second registration process (which may end, according to an embodiment of the invention, by sending to the child wireless unit, an acknowledgement of a registration request of the child wireless unit); to receive from the child wireless unit a received message that include identification information of a wireless unit other than first wireless unit 200 and other than the father unit; and to transmit the received message at the small number of transmissions per hour and at the low power mode to the father unit, via transmitter 250. According to various embodiments of the invention, the small number of transmissions per hour may be defined differently. According to an embodiment of the invention, the small number of transmissions per hour is lower than one message per 10 minutes. According to an embodiment of the invention, the small number of transmissions per hour is lower than one message per 20 minutes. According to an embodiment of the invention, the small number of transmissions per hour is lower than one message per 1 hour. According to an embodiment of the invention, the small number of transmissions per hour is lower than one message per 1 day, etc.

It is noted that first wireless unit 200 may include one or more processors (not illustrated) which may be shared, according to an embodiment of the invention, by components 220, 230, 240, etc. First wireless unit 200 may also include, according to an embodiment of the invention, transmitter 250 (which may be, according to an embodiment of the invention, a transceiver) which may implement the transmission and possibly also of reception of wireless communication and which may include a PHY level component and higher layer components (e.g. LINK level component). Transmitter 250 may also be shared by multiple components such as 220, 230, and 240.

According to an embodiment of the invention, first wireless unit 200 may also include one or more sensors 260. Each such sensor 260 adapted to detect an environmental condition and to generate in response environmental condition information, wherein message generator 230 is further adapted to include in at least some of the messages environmental condition information received from one or more of the sensors 260.

For example, some sensors may be a temperature sensor, a sensor sensitive to the concentration of a certain gas, an air pressure sensor, etc.

According to an embodiment of the invention, one or more of the sensors 260 is configured to detect an environmental condition indicative of a condition of goods that are conveyed by a conveyable storage unit to which the first wireless unit is assigned. For example—high temperature may indicate that the condition of dairy product is deteriorating. High sulfur concentration may indicate that a hazardous material is not safely packed.

According to an embodiment of the invention, relay component 240 is operational only if the first wireless unit 200 is allowed, by a wireless network leader of a wireless network to which first wireless network 200 belongs, to be a non-barren wireless unit. This allowing may be, for example, by an order to first wireless unit 200, by a general indication of the maximum number of ranks allowed, etc.

According to an embodiment of the invention, the first wireless unit 200 is integrated into a conveyable storage unit—e.g. a box, a crate, a pallet, a tray, a cargo container, etc.

4 According to an embodiment of the invention, first wireless unit 200 may be detachably attached to a conveyable storage unit (e.g. by adhesive tape, by being placed in or on the conveyable storage unit, etc.).

According to other embodiments of the invention, first wireless unit 200 may be suited to the other functionalities disclosed herein—e.g. be connected to a livestock animal, to a shipping crate, etc.

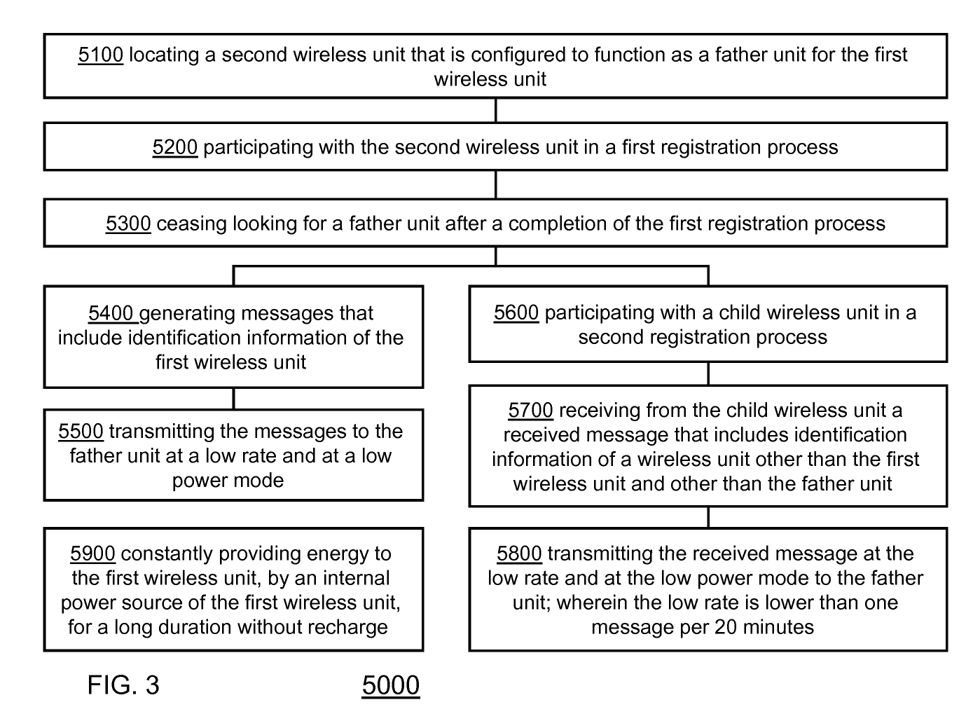

FIG. 3 illustrates method 5000 for wireless communication, according to an embodiment of the invention. Method 5000 includes carrying out of its various stages by components of a first wireless unit (such as wireless unit 200).

Method 5000 includes stage 5100 of finding a second wireless unit that is configured to function as a father unit for the first wireless unit.

Stage 5100 is followed by stage 5200 of participating with the second wireless unit in a first registration process.

Method 5000 may further include stage 5300 of ceasing looking for a father unit after a completion of the first registration process (e.g. after receiving from the father unit an acknowledgement of the registration). It is noted that, according to an embodiment of the invention, stage 5300 may not be implemented, and that either directly after joining the network, or after an intermission in looking for a father unit, the first wireless unit that is already connected to the wireless network may look again for another father unit—e.g. to reduce the number of hops from the wireless network leader of the wireless network.

Stage 5400 of method 5000 includes generating messages that include identification information of the first wireless unit. It is noted that the messages may be generated routinely (e.g. every half an hour), and/or in response to predefined conditions met (e.g. due to sensor information).

Stage 5400 is followed by stage 5500 of transmitting the messages to the father unit at a small number of transmissions per hour and at a low power mode. Method 5000 further includes stage 5600 of participating with a child wireless unit in a second registration process. It is noted that the second registration process may include a request by the child wireless unit to join the wireless network (e.g. after finding the first wireless unit as a part of the wireless network), affirming by the first wireless unit that it may accept a new member as a child wireless unit (e.g. it is non-barren and did not exceed its maximum number of sons), and sending to the child wireless unit an acknowledgement of its registration request.

Stage 5600 is followed by stage 5700 of receiving from the child wireless unit a received message that includes identification information of a wireless unit other than the first wireless unit and other than the father unit; and by stage 5800 of transmitting the received message at the small number of transmissions per hour and at the low power mode to the father unit; wherein the small number of transmissions per hour is lower than one message per 20 minutes (or one of the other rates indicated above—lower than 10 minutes, lower than 1 hour, lower than 1 day, etc.).

It is noted that method 5000 may further include stage 5900 of constantly providing energy to the first wireless unit, by an internal power source of the first wireless unit, for a long duration without recharge. According to an embodiment of the invention stage 5900 includes providing energy to the first wireless unit constantly or intermittently, by a power source.

It is noted that stages 5400 and 5500 may be iterated multiple times, and that stages 5600, 5700, and 5800 may be carried out for different sons and that stages 5700 and 5800 may be reiterated for the same son.

According to an embodiment of the invention, method 5000 further includes detecting, by a sensor of the first wireless unit, an environmental condition and generating in response to the sensor environmental condition information; wherein stage 5400 includes at least some of the messages environmental condition information received from the sensor.

According to an embodiment of the invention, wherein the detecting further includes detecting an environmental condition indicative of a condition of goods that are conveyed by a conveyable storage unit to which the first wireless unit is assigned.

According to an embodiment of the invention, the stages of participating with the child wireless unit in the second registration process, receiving the received message and transmitting the received message are selectively carried out only if the first wireless unit is allowed by a wireless network leader to be a non-barren wireless unit.

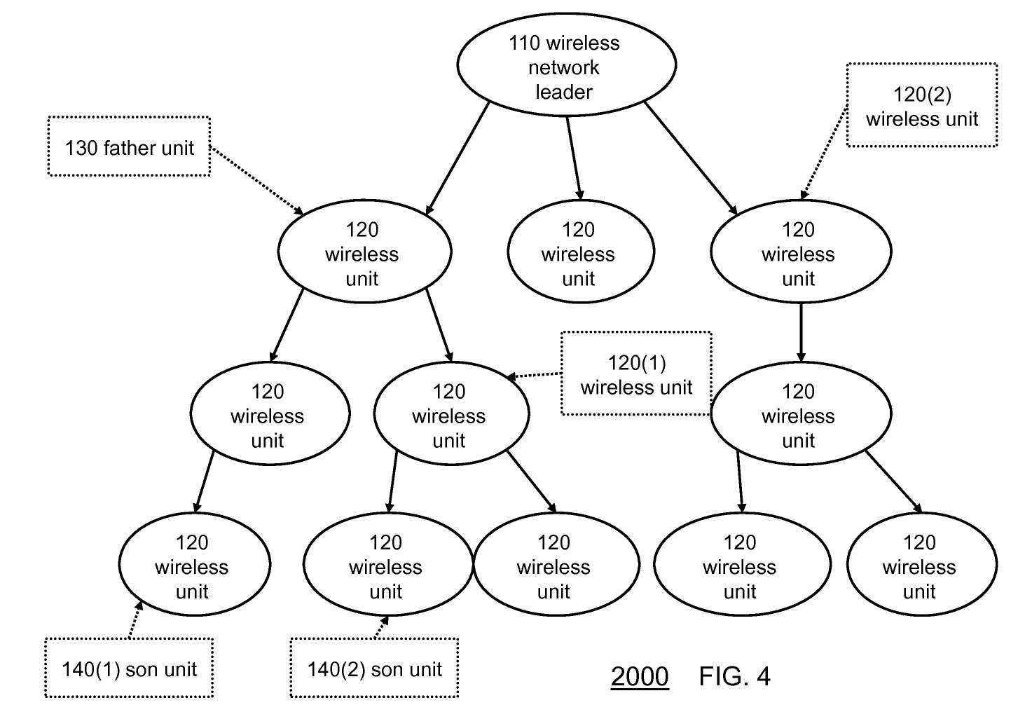

According to an embodiment of the invention, the stages of method 5000 are carried out by components of the first “wireless unit” that are integrated into a conveyable storage unit. FIG. 4 illustrates a low complexity wireless network 2000, according to an embodiment of the invention. Wireless network 2000 includes wireless network leader 110, and multiple low-power wireless units 120.

Each wireless unit (e.g. 120(1)) of network 2000 is registered with a single father 130; wherein each wireless unit 120 is either a barren wireless unit that is prevented from registering sons, or a non-barren wireless unit that may parent up to a predetermined number of sons (e.g. 1, 3 sons).

Each of the wireless units 120 of network 2000 may transmit messages only to its father (like unit 130) or to a son wireless unit 140 of it (e.g. son 140(1)), wherein some of the message transmitted are messages relayed from a son wireless unit 140 to the father 120.

According to an embodiment of the invention, all the messages in network 2000 that do not originate from the wireless network leader 110 are messages that are directed to the wireless network leader 110. According to another embodiment of the invention, messages may also be transmitted and/or relayed between different members, usually according to the structure (e.g. via the leader 110, between units 120(1) and 120(2)).

According to an embodiment of the invention, wireless network leader 110 of low complexity wireless network 2000 is further configured to determine an allowed number of ranks in the low complexity wireless network 2000, wherein each of the wireless units 120 is prevented to parent other wireless units if a rank of its son wireless unit would exceed the allowed number of ranks.

According to an embodiment of the invention, wireless network leader 110 is adapted to communicate with at least one wireless network leader of at least one other network (not illustrated) in order to determine channel allocation between the networks; wherein—according to an embodiment of the invention—each of the wireless network leaders is prevented from communicating with the multiple low-power wireless units of the other at least one network. According to an embodiment of the invention, non-barren wireless units 120 are further adapted to acknowledge wireless units to the low complexity wireless network without antecedently informing the wireless network leader.

According to an embodiment of the invention, each of the multiple low-power wireless units 120 includes a sensor, and is adapted to transmit through its father a message for the wireless network leader that includes environmental condition information generated by its sensor.

According to an embodiment of the invention, each of the low-power wireless units 120 is located in a conveyable storage unit, wherein the wireless network leader is configured to determine a condition of a storage environment in which the wireless units are located, wherein the determining is carried out in response to environmental condition information received from the different wireless units.

For example, such storage environment may be a warehouse, a shipyard, a refrigeration environment, a truck, etc. It is noted that management of storage components in a storage environment (e.g. warehouse, etc.) is enabled in a variety of industries—even without the sensors. For example, wireless units and network as disclosed may be used for determining when a book is removed to a library, etc.

According to an embodiment of the invention, wireless network leader 110 is adapted to generate an alarm in response to environmental condition information received from at least one of the low-power wireless units. According to an embodiment of the invention, wireless network leader 110 is adapted to generate an alarm in response to information received from a combination or sequence of signals received from multiple low-power wireless units.

According to an embodiment of the invention, barren wireless units in the low complexity wireless network 2000 are adapted to routinely look for an alternative father that has fewer hops to the wireless network leader, and/or to look for an alternative father if instructed to do so by the leader.

According to an embodiment of the invention, non-barren wireless units are converted to barren wireless units if they do no parent other wireless units after a predetermined time interval.

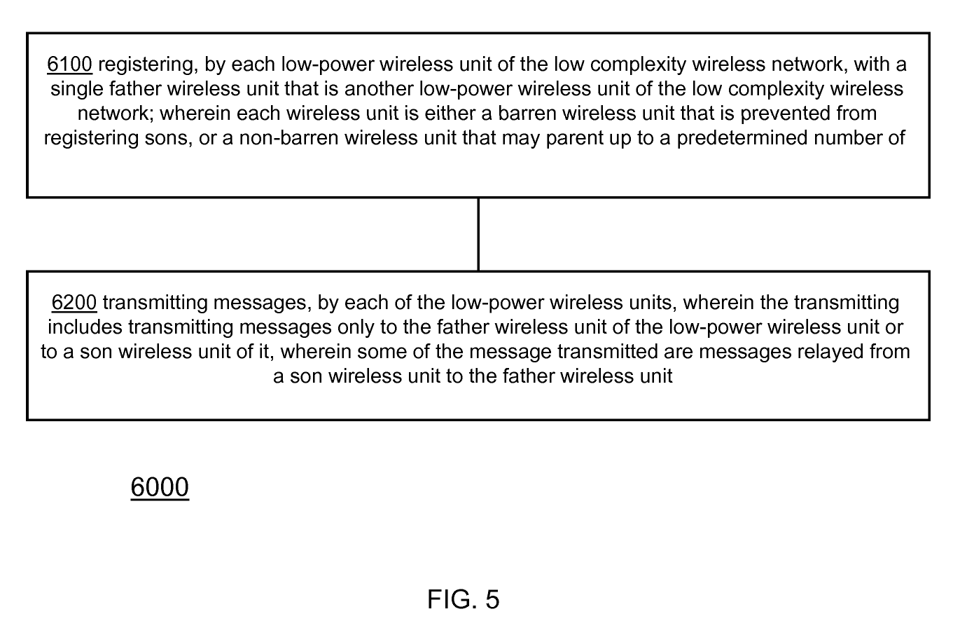

FIG. 5 illustrates method 6000 for operating a low complexity wireless network, according to an embodiment of the invention. Method 6000 may be implemented, according to an embodiment of the invention, in network 2000 and/or in other wireless networks disclosed.

Method 6000 includes stage 6100 of registering, by each low-power wireless unit of the low complexity wireless network, with a single father that is another low-power wireless unit of the low complexity wireless network; wherein each wireless unit is either a barren wireless unit that is prevented from registering sons, or a non-barren wireless unit that may parent up to a predetermined number of sons.

Method 6000 further includes stage 6200 of transmitting messages, by each of the low-power wireless units, wherein the transmitting includes transmitting messages only to the father of the low-power wireless unit or to a son wireless unit of it, wherein some of the messages transmitted are messages relayed from a son wireless unit to the father.

According to an embodiment of the invention, in method 6000 all the messages in the network that do not originate from a wireless network leader of the low complexity wireless network are messages that are directed to the wireless network leader. However, this is not necessarily so.

According to an embodiment of the invention, method 6000 further includes determining, by the wireless network leader, an allowed number of ranks in the low complexity wireless network, wherein each of the wireless units is prevented to parent other wireless units if a rank of its son wireless unit would exceed the allowed number of ranks.

According to an embodiment of the invention, method 6000 further includes communicating, by the wireless network leader, with at least one wireless network leader of at least one other wireless network in order to determine channel allocation between the networks; wherein each of the wireless network leaders is prevented from communicating with the multiple low-power wireless units of the other at least one wireless network. According to an embodiment of the invention, plurality of leaders may be enabled to communicate. Each network, for example, may have a distinct sequence of channels in time and frequency. A network may use a single frequency or use multiple frequencies in a dynamic manner (frequency hopping).

According to an embodiment of the invention, method 6000 further includes acknowledging wireless units to the low complexity wireless network, by non-barren wireless units of the low complexity wireless network, without antecedently informing the wireless network leader.

According to an embodiment of the invention, method 6000 further includes transmitting through its father, by each of the multiple low-power wireless units, a message for the wireless network leader that includes environmental condition information generated by a sensor included in that wireless unit. According to an embodiment of the invention, method 6000 further includes determining, by the wireless network leader, a condition of a storage environment in which the wireless units are located, wherein the determining is carried out in response to environmental condition information received from the different wireless units that are located in conveyable storage units. According to an embodiment of the invention, method 6000 further includes determining, by the wireless network leader, a condition of the stored goods wherein the determining is carried out in response to environmental condition information or information regarding the condition of the goods being monitored or information regarding the condition of the containers or packaging of the goods being monitored, received from the different wireless units that are located in conveyable storage units. According to an embodiment of the invention, method 6000 further includes determining, by the wireless network leader, a condition of the containers and or packaging of the goods wherein the determining is carried out in response to environmental condition information or information regarding the condition of the goods being monitored or information regarding the condition of the containers or packaging of the goods being monitored, received from the different wireless units that are located in conveyable storage units.

According to an embodiment of the invention, method 6000 further includes generating an alarm, by the wireless network leader, in response to environmental condition information received from at least one of the low-power wireless units. According to an embodiment of the invention, method 6000 further includes generating an alarm, by the wireless network leader in response to information received from a combination or sequence of signals received from multiple low-power wireless units.

According to an embodiment of the invention, method 6000 further includes routinely looking, by barren wireless units in the low complexity wireless network, for an alternative father that has fewer hops to the wireless network leader.

According to an embodiment of the invention, method 6000 further includes converting non-barren wireless units to barren wireless units if they do no parent other wireless units after a predetermined time interval. According to an embodiment of the invention, method 6000 further includes converting non-barren wireless units to barren wireless units per leader prerogative for example if the leader decides to change the network structure and or to limit the amount of ranks. It is noted that both network 2000 and method 6000 (as well as other systems, networks, and method disclosed herein) are especially suitable for high attenuation environments, in which most likely many of the wireless units cannot have direct wireless communication with the network leader, and where wireless connections are likely to be broken, and reconnection to the network may be necessary. Such high attenuation conditions are very dominant in many environments and especially in storage/cargo areas (e.g. ship, truck, warehouse etc.).

According to an embodiment of the invention, high attenuation conditions refer to attenuation levels above 90 dB, According to another embodiment of the invention high attenuation conditions include attenuation level that prevents reliable communication between a network leader and a member based on the available energy to the member or the leader. According to an embodiment of the invention, high attenuation environments include water rich elements like fresh produce, chemicals and fluids. According to another embodiment of the invention, high attenuation environments include materials that absorb or reflect electromagnetic radiation like concrete or metal walls and doors. According to another embodiment of the invention, high attenuation environments include a combinations of the above mentioned environments, for example; a container full of fruits, a silo of nuts or chemicals, warehouse with metal structures, cooling rooms with concrete walls and metal doors, a corrugated box with aluminum coating. According to another embodiment of the invention, high attenuation environments can be static, like a sensor mounted in a silo, According to another embodiment of the invention, high attenuation environments can be dynamic, where the attenuation levels varies, like warehouses with doors that open and close.

The simple connection and transmission scheme discussed above enables the use of wireless units (“nodes”) of low complexity, and of ultra low power consumption. Specifically, every unit needs to communicate only with nearby units, wherein communication to remote units is relayed by nearby units.

Such systems, networks, and methods may be used, inter alia, for tracking status of multiple shipments all over the world.

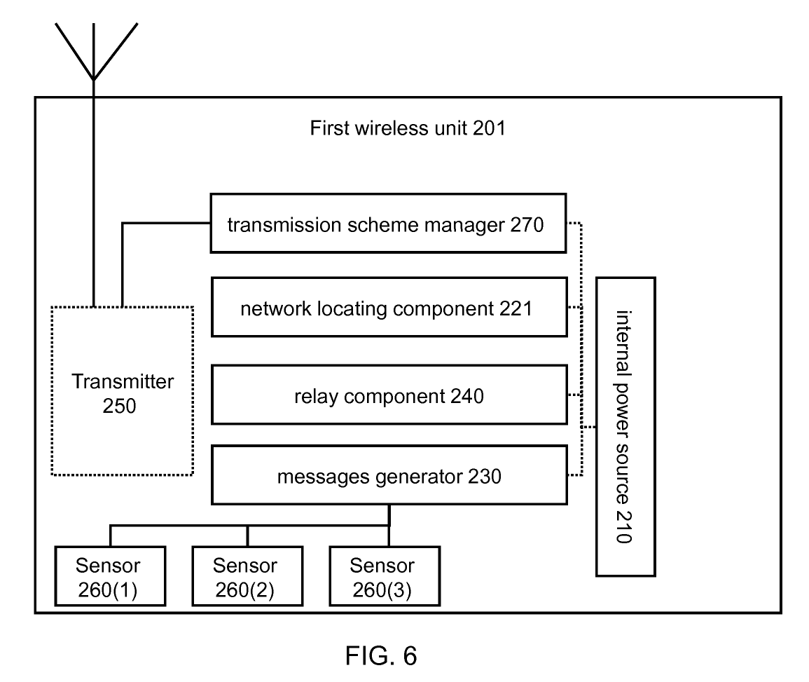

FIG. 6 illustrates wireless unit 201, according to an embodiment of the invention. It is noted that wireless unit 201 may be implemented in the various wireless networks disclosed, and that it may also be implemented as a wireless unit 200 as well. Some components that were already disclosed in relation to wireless unit 200 and which may be implemented in wireless unit 201 according to various embodiments of the invention are not disclosed again.

Wireless unit 201 includes network finding component 221, adapted to find another wireless unit that belong to a wireless network that is characterized by a low average rate of transmission, and to join the wireless network.

Wireless unit 201 further includes a transmission scheme manager 270, configured to manage the transmission of the wireless unit 201 when it is connected to the wireless network. Conveniently, transmission scheme manager 270 may be further configured to transmit transmission management information to transmitter 250, wherein transmitter 250 is configured to carry out its transmission according to the transmission management information received from transmission scheme manager 270. According to an embodiment of the invention the transmission scheme manager 270, is configured to manage the transmission of the wireless unit 201 when it is not connected to a wireless network.

According to an embodiment of the invention, transmission scheme manager 270 is further configured to manage reception scheme according to which a transceiver 250 is configured to carry out reception (e.g. duration when the transceiver may be in a sleep mode, etc.). According to an embodiment of the invention, transmission scheme manager 270 may manage the transmission and/or reception scheme at least partly in response to order received from the wireless network leader. Wireless unit 201 further includes a transmitter 250 that is configured to: i. transmit according to a high transmission scheme that includes transmission, at a large number of transmissions per hour, signals that indicate the availability of the wireless network to wireless units that are not part of the wireless network; and ii. transmit according to a low transmission scheme that includes transmission at a small number of transmissions per hour signals used for communication within the wireless network.

Wireless unit 201 may include, according to an embodiment of the invention, an internal power source 210, adapted to provide energy to the first wireless unit for a long duration without recharge. According to an embodiment of the invention wireless unit 201 may include, multiple internal power sources adapted to provide energy to the first wireless unit. According to an embodiment of the invention wireless unit 201 may include, an internal power source 210, adapted to provide energy to the first wireless unit for a long duration, constantly or intermittently without recharge. According to an embodiment of the invention wireless unit 201 may include a rechargeable internal power source, adapted to provide energy to the first wireless unit. According to an embodiment of the invention wireless unit 201 may include, an external power source, adapted to provide energy to the first wireless unit. According to an embodiment of the invention wireless unit 201 may include, an external and an internal power source 210, adapted to provide energy to the first wireless unit.

According to an embodiment of the invention, transmission scheme manager 270 is configured to dictate starting of transmission according to the high transmission scheme substantially upon joining a network.

According to an embodiment of the invention, transmission scheme manager 270 is configured to dictate switching to transmitting according to the low transmission scheme in response to various parameters. According to an embodiment of the invention, transmission scheme manager 270 is configured to dictate switching to transmitting according to the high transmission scheme in response to joining to the network by one of the wireless units that are not part of the wireless network.

According to an embodiment of the invention, transmission scheme manager 270 is configured to dictate starting of transmission according to the high transmission scheme in response to detection of an environmental condition by a sensor of the wireless unit.

According to an embodiment of the invention, wireless unit 201 is configured to join a wireless network in which the non-leading wireless units of the network ordinarily transmit according to the low transmission scheme.

According to an embodiment of the invention, network finding component 221 is configured to find another wireless unit by detecting high transmission scheme signals sent by the another wireless unit of the wireless network, wherein the wireless unit joins the wireless network as a son of the another wireless unit. According to an embodiment of the invention, network finding component 221 is configured to find another wireless unit by detecting transmission scheme signals sent by the another wireless unit of the wireless network, wherein the wireless unit joins the wireless network as a son of the another wireless unit.

According to an embodiment of the invention, network finding component 221 is configured to search for a wireless network for a duration longer than a week prior to detecting the another wireless unit. Such durations may also be longer than 14 days, a month, a year, etc.

According to an embodiment of the invention, components of wireless unit 201 are adapted for wireless communication in high attenuation environments. According to an embodiment of the invention, components of wireless unit 201 may be adapted for wireless communication in high attenuation environments.

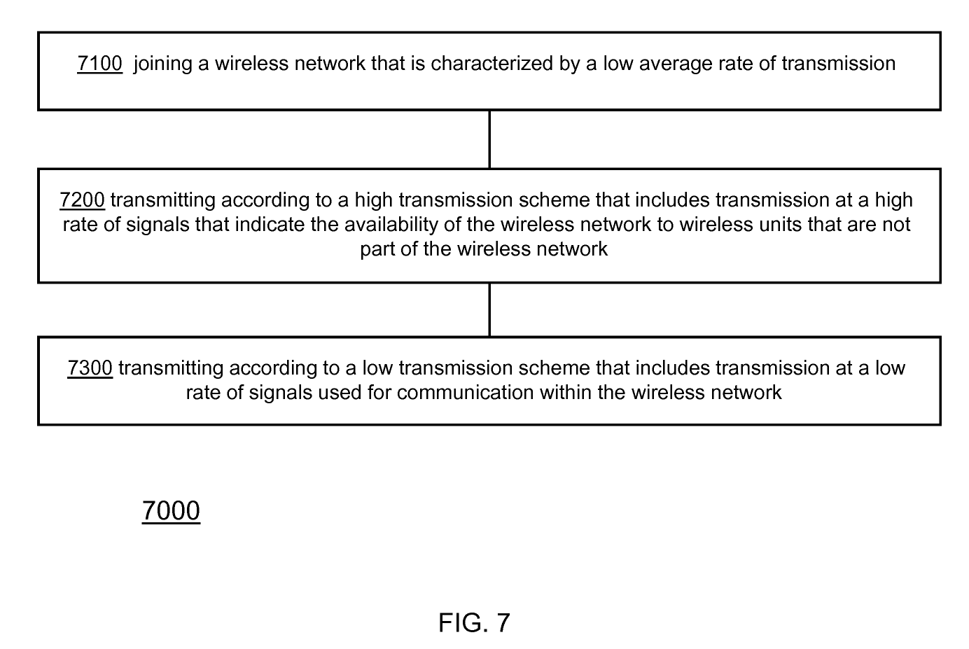

FIG. 7 illustrates method 7000 for fast network detection in a wireless network, according to an embodiment of the invention. It is noted that the wireless network may be a TDMA network but this is not necessarily so. Method 7000 includes carrying out its stages by a wireless unit (such as wireless unit 200, 201, or other wireless units—discussed herein). Stage 7100 of method 7000 includes joining a wireless network that is characterized by a low average rate of transmission.

Stage 7100 is followed by stage 7200 of transmitting according to a high transmission scheme that includes transmission, at a large number of transmissions per hour, signals that indicate the availability of the wireless network to wireless units that are not part of the wireless network.

Stage 7300 of method 7000 includes switching to transmitting according to a low transmission scheme that includes transmission, at a small number of transmissions per hour, signals used for communication within the wireless network.

According to an embodiment of the invention, the transmitting according to the high transmission scheme begins substantially with the joining to the wireless network.

According to an embodiment of the invention, the switching is carried out in response to joining to the wireless network by one of the wireless units that are not part of the wireless network. According to an embodiment of the invention, the timing of the switching from a high duty cycle of transmission to a low duty cycle of transmission is a function of the amount of power available to the wireless unit. For example, if the power level is less than 30% of the original power level, the high duty cycle duration can be reduced to 50% of the original duty cycle duration. In another embodiment, the high duty cycle duration will be proportional to the amount of power remaining for example, if the power level is 60% of the original power level, the duty cycle duration will be 60% of the original duty cycle duration. According to an embodiment of the invention, the timing of the switching from a high duty cycle of transmission to a low duty cycle of transmission is a function of probability of detecting additional nearby wireless units, For example, if the probability is high, such as when the network is being established, the switching time can be postponed resulting in a longer duration of a high duty cycle of transmission in order to reduce the average time needed for network detection by non connected wireless units.

According to an embodiment of the invention, the timing of the switching from a high duty cycle of transmission to a low duty cycle of transmission is a function of the number of available slots for connecting new sons, of the transmitting wireless unit. If the wireless unit has connected sons in most of its slots, it may choose to switch to a low duty cycle of transmission in-order to conserve power or to balance out the network. According to an embodiment of the invention, the timing of the switching from a high duty cycle of transmission to a low duty cycle of transmission for a given wireless unit is determined by the leader. For example, if the leader chooses to maintain a wide network with few ranks, it may direct wireless units that have recently joined the network to minimize the high duty cycle of transmission. In another embodiment, it will define them as barren wireless units.

According to an embodiment of the invention, the transmission power level during a high duty cycle of transmission and the duration of the high duty cycle of transmission are defined based on the probability of finding a network. For example, if the probability is high, such as when there are multiple sensor indications, in a short time period, the transmission power level and or duration of the high duty cycle of transmission, can be increased.

According to an embodiment of the invention, multiple sensor indications are multiple indications from a single sensor. In another embodiment, multiple sensor indications are derived from multiple sensors. In another embodiment, the multiple sensor indications are derived from similar type sensors and in another embodiment, the multiple sensor indications are derived from non similar type sensors. It is noted that the terms “transmissions scheme”, “transmissions per hour” etc., and “duty cycle of transmission” are used interchangeably throughout the disclosure.

According to an embodiment of the invention, transmission according to the high transmission scheme is initiated by the wireless unit in response to detection of an environmental condition by a sensor of the wireless unit.

According to an embodiment of the invention, the joining to the wireless network includes joining the wireless network in which the non-leading wireless units of the wireless network ordinarily transmit according to the low transmission scheme.

According to an embodiment of the invention, the joining is carried out in response to detection of high transmission scheme signals sent by a wireless unit of the wireless network, wherein the joining includes joining the wireless network as a son of that wireless unit. According to an embodiment of the invention, the joining is carried out in response to detection of transmission signals sent by a wireless unit of the wireless network.

According to an embodiment of the invention, the joining is preceded by searching for a wireless network for duration longer than a week. According to an embodiment of the invention, the joining is preceded by searching for a wireless network for duration longer than a day. According to an embodiment of the invention, the joining is preceded by searching for a wireless network for duration longer than a month or other predetermined duration According to an embodiment of the invention, network nodes (wireless units) may be “sleeping” most of the time and to wake up at the exact time needed to perform data transfer and network sync.

It is noted that method 7000 (and wireless unit 201) are particularly useful for networks where the network existence is not assured and the nodes are spending a major part of their lifespan searching for a network.

According to an embodiment of the invention, as soon as one of the nodes detects the network, it starts to transmit network beacons on a large number of time slots of the TDMA system.

According to an embodiment of the invention, wireless units may change their states in accordance with environmental changes, which in turn enable the wireless nodes to change their transmission scheme.

According to an embodiment of the invention, once an adjacent member, a second member in this case, detects a valid network beacon message, the fast network detection algorithm for the first member stops its operation.

According to an embodiment of the invention, method 7000 (and wireless unit 201) enable fast network formation in cases such as external scenarios requiring handling by the network.

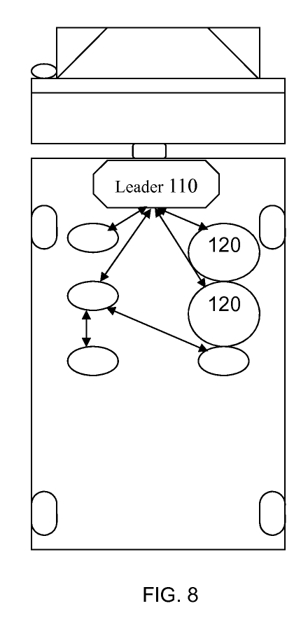

Reference is now made to FIG. 8, which illustrates an application of the herd network in a truck and trailer configuration, according to an embodiment of the invention. This is an example of a “narrow” tree formation, according to some embodiments. For example, where there are multiple products packed in crates or pallets etc. being transported, a herd network may be set up to enable communication of storage related data etc. in the storage compartment or external to the storage compartment (e.g., in the truck driver compartment). According to an embodiment of the invention, wireless units are placed external to the storage compartment. For example, such wireless units can provide comparative environmental information such as temperature external to the storage unit. According to an embodiment of the invention, wireless units are placed external to the storage compartment and used for “look ahead” information. For example, if a refrigerator container transporting goods is planned to be opened in a non temperature controlled location, the external wireless units can provide “look ahead” data informing the system managers of the magnitude of the temperature change and or humidity conditions that the goods will encounter.

According to an embodiment of the invention, the wireless network leader is located external to the storage compartment, in a location wherein there is external power supply available to the leader. According to an embodiment of the invention, the wireless network leader is located external to the storage compartment in a location wherein transmission quality, for example; to other networks, is better than in the storage compartment.

According to an embodiment of the invention, the wireless network leader is located in the truck driver/train driver/ship-captain/pilot compartment.

The configuration illustrated in FIG. 8, for example, may support 14 ranks with up to 14*4 members in each rank (total of 784 members). This configuration may be referred to as a narrow herd formation The truck and trailer configuration may be implemented in a train environment, ship environment, plane environment etc. According to an embodiment of the invention, multiple configurations such as the configuration illustrated in FIG. 8, may be implemented side by side or in close proximity. For example in a warehouse, in a vegetable field or in a truck stop.

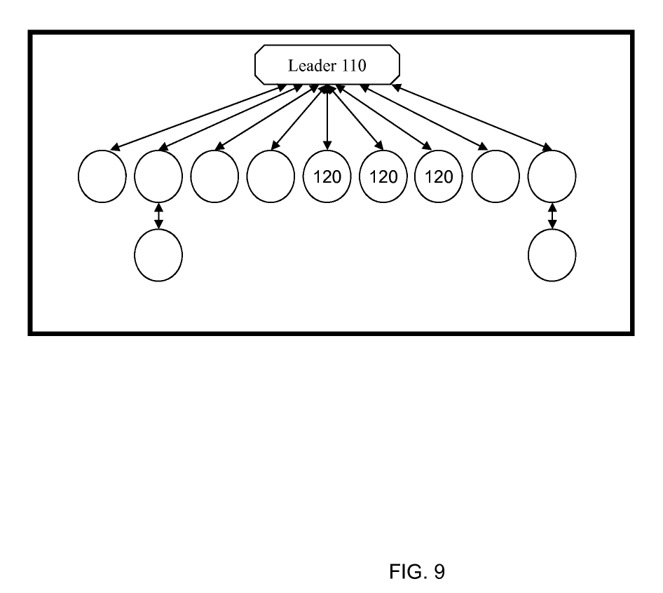

According to some embodiments a plurality of leaders (each leader representing its own small or narrow network) may be enabled to communicate, thereby forming a broader or larger network. Each network, for example, may have a distinct sequence of channels in time and frequency. A network may use a single frequency or use multiple frequencies in a dynamic manner (frequency hopping). It is noted that the terms “narrow tree formation” and “narrow heard formation” are used interchangeably throughout the disclosure. Reference is now made to FIG. 9, which illustrates an application of the herd network in a warehouse, refrigerator, or ship type configuration, according to an embodiment of the invention. This is an example of an implementation of a “flat” tree formation. For example, where there are multiple products packed in containers, boxes, crates or pallets etc. being stored, a herd network may be set up to enable communication of storage related data etc. to an internal and/or external data management system. According to an embodiment of the invention, the wireless leader 110 is constantly located in the warehouse, while wireless units 120 are located in the boxes that may enter and leave the warehouse. According to an embodiment of the invention, the wireless leader 110 is located with the warehouse, while wireless units 120 are located in the boxes, crates or pallets etc. that may enter and leave the warehouse. According to an embodiment of the invention, the wireless leader 110 enters the warehouse with the wireless units 120 that are located in the boxes.

The configuration illustrated in FIG. 9, for example, may support 2 ranks, where a first rank can have as many as 127 members. Each member can have up to 4 barren sons in the next rank. This configuration may be referred to as a flat herd formation, which may enable formation of a herd network with a total of 635 members.

According to some embodiments, a herd type network may be set up to enable communications in high attenuation environments, for example, in a warehouse, shipyard, or refrigeration environment where multiple stacks of containers, pallets, boxes etc. are present. In one example, typical communication link attenuation between two wireless sensors placed arbitrarily inside pallets loaded with fresh produce can reach more than 100 dB. Using the Ad-Hoc and multi-hop network, each sensor constantly looks for a hub or other sensors that can connect it to a hub. The sensors are placed, for example, in the fresh produces or product boxes. The boxes may be placed one on top of the other, in a pallet. In some embodiments there is one tag per pallet, such that when the pallets are moved along the cold chain, from the packing house till the retailer shelves, the sensors will be able maintain an ultra low complexity wireless link, thereby enabling communication of data between multiple sensors in the wireless network. It is noted that the terms “hub”, “hub node” “root”, “root node” “leader” and “leader node” are used interchangeably throughout the disclosure. It is noted that the terms “tag”, “members”, “nodes” and “wireless unit” are used interchangeably throughout the disclosure.

According to some embodiments a plurality of leaders (each leader representing its own small or thin network) may be enabled to communicate, thereby forming a broader or larger network. Each network, for example, may have a distinct sequence of channels in time and frequency. A network may use a single frequency or use multiple frequencies in a dynamic manner (frequency hopping).

Networks may or may not have inter-communication capabilities. Without such capabilities, the networks may be synchronized so they do not interfere with each other. This could be achieved either by using different frequencies or by careful selection of the frequency hopping sequences. The leaders of the network may or may not communicate with each other to make better use of the spectrum. Without communication, the leaders may select a channel or a hopping sequence and continuously monitor the spectrum to prevent mutual interference. When communicating with each other, the leaders may synchronize the use of the spectrum between themselves, by achieving direct communication over the air.

The herd network supports a cluster tree topology, wherein the network has one root node (leader) and all communication is routed to the leader. Member to member communication has one primary purpose: to relay data to the leader or from the leader. The network topology may be controlled by the leader. In some embodiments there are two predefined configurations—“flat” and “Narrow”, however other configurations may be defined, per the requirements of the installation. Member to member communication has additional purposes such as registration procedures. According to some embodiments member to member communication includes “keep alive” communications that indicate that the connection between the networks and each individual wireless unit is still active. According to some embodiments “keep alive” communications are from father to son. The absence of “keep alive” communication will alert the individual wireless unit that it may have disconnected from network. According to some embodiments the absence of “keep alive” communications is defined as no communication over 5 minutes. According to other embodiments the absence of “keep alive” communications is defined as no communication over 5 hours. According to other embodiments the absence of “keep alive” communications is defined as no communication over 25 days or other specified time interval. According to some embodiments, three unsuccessful “keep alive” communications indicates that connection with the network has ceased. According to some embodiments, ten (or other predetermined number, of) unsuccessful “keep alive” communications, indicates that connection with the network has ceased.

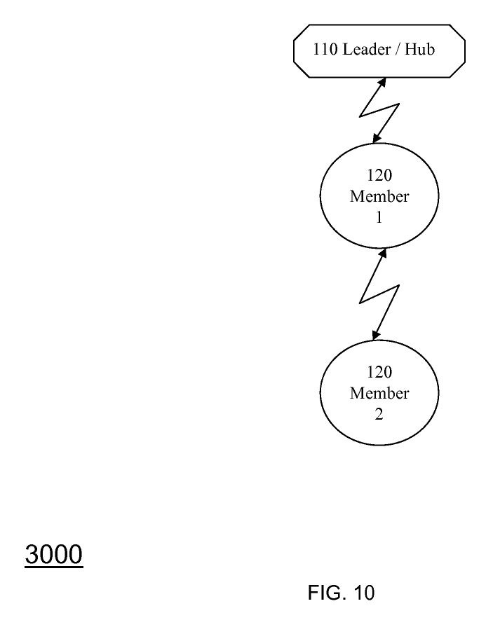

Reference is now made to FIG. 10, which illustrates an embodiment of a herd wireless network 3000, according to an embodiment of the invention. Herd wireless network 3000 includes a hub or leader node and multiple sensors, or member nodes. Each sensor node may connect directly to the hub or to another sensor node that is directly or indirectly connected to the hub. The abovementioned arrangement allows for the creation of a cluster tree network of wireless sensor nodes. As can be seen in the FIG. 10, in such a configuration the leader has no control or even no knowledge of member 2 connecting to the network. The connection is formed by simple rules practiced by the leader and a member (1). Connections between members are also formed by simple rules practiced by member 1 and member 2.

In some embodiments of the herd wireless network, the root node has no control over the network topology. The topology in such a case may be set by very simple rules of each node, for example: A member may connect to any other member of a leader that has a free connection slot. The member may identify a free slot by a special flag in the slot. A member or a leader may allow other members to connect as long as it has free slots. A leader can handle directly connected members, for example up to 127 directly connected members (as described in the above described basic herd network). A member may typically handle up to 4 directly connected members. Each node may join the network on an available slot basis. A connection may be established only in cases where the reception is adequate to maintain a reliable connection. Channel availability may be fully controlled by the father, being the leader or a member. Each member has a maximum number of channels assigned to sons. Only a subset of the sons of a father may have sons of themselves. The above rules are examples, for illustration purposes. Other rules or combinations of rules may be used.

According to some embodiments, the herd network properties may include one or more of: A one hub, many sensor networks; cluster tree (mesh) topology and a low code and data footprint for network member tag software (e.g., the tags or members may integrate a small code needed to perform all the relevant network algorithms). In some implementations tags may leave and join networks (i.e. Ad-Hoc), and the network may deliver information in one direction (toward the hub), where the hub is the leader of the herd. It is noted that the terms “mesh”, “mesh network”, “mesh topology” “network” and “network topology” are used interchangeably throughout the disclosure.

According to some embodiments the tag may enable longevity over several months (e.g. 90 days or more) on a low energy battery (e.g. 60 mAh battery, or lower). For example, out of the 90 days, the tag power source (e.g. battery) may be configured to handle 45 days without network connection (searching for network and storing measurements samples) and 45 days connected to a network. Other batteries, power sources, sampling rates etc. may be used, and other tag properties may be used.

According to an embodiment of the invention, various types of sensors may be implemented (e.g. up to 8 different sensors, such as temperature, relative humidity, oxygen and others). According to an embodiment of the invention, various types of sensors may be implemented in an array of sensors (e.g. sensors capable of detecting, oxygen, tilt, light, acceleration etc.). According to an embodiment of the invention, various configurations of sensors may be implemented such as multiple sensors of the same type, for example, humidity sensors, in-order, for example, to increase data reliability.

According to an embodiment of the invention, the power source may have a maximum sampling rate of, for example, once every 30 minutes. Faster rates may be allowed, for example, in debug modes. According to an embodiment of the invention, the power source may have a maximum sampling rate of, for example, once every 2 minutes, in debug modes or during system verification and or calibration. According to an embodiment of the invention, software debug and verification and or system and or sensor calibration can be done remotely. According to some embodiments, one or more sensing mechanisms may be integrated into the herd wireless network, using multipoint configuration. In some examples, sensors for monitoring temperature, product integrity, time intervals, humidity, light etc. may be used. For example, a warning system based ultra low complexity wireless network may be used to monitor the selected storage environment, and alert the driver or monitoring service as to a problematic change in the storage environment. In a further example, the herd wireless network may send updated storage environment status updates to a monitoring service to enable tracking of environment status and location status in real time, around the world. This application may be used to enhance quality control, safety standards and client service for transporters or handlers of cold chain goods.

According to some embodiments this application may be used to enhance quality control, safety standards and client service for transporters or handlers of for example; live products, e.g. animals, short shelf life products, hazardous products, high value goods etc.

According to further embodiments, the herd wireless network may be integrated into cold chain management for the dairy industry. For example, it may be necessary to monitor transports of cheeses, milks, formulas, butters, fats, proteins, yogurts, ice-creams etc. to ensure that recommended storage temperatures are maintained while transporting.

According to further embodiments, the herd wireless network may be integrated into cold chain management for the sea food industry. For example, it may be necessary to monitor transports of sea food, whether alive or pre or post processing, to ensure that recommended storage environments are maintained while transporting. In the case of live transports, sensors monitoring the health status of living creatures may be used.

According to further embodiments, the herd wireless network may be integrated into cold chain management for the livestock industry. For example, it may be necessary to monitor transports of livestock, whether alive or pre or post processing, to ensure that recommended storage environments are maintained while transporting. In the case of live transports, sensors monitoring health status's of the live animals may be used. In other cases the location of the livestock in transit may be determined at all times.

According to various embodiments of the invention, systems, networks, and methods as disclosed above may implemented for monitoring of the environment of livestock—monitoring the conditions e.g. temperature, humidity, gases in the air (such as methane).

According to various embodiments of the invention, systems, networks, and methods as disclosed above may implemented for monitoring livestock (e.g. for health issues, e.g. by monitoring their body temp).

According to various embodiments of the invention, systems, networks, and methods as disclosed above may be implemented for monitoring livestock location to prevent stealing, increase fruitfulness, milk production etc.

According to further embodiments, ultra low complexity wireless networking, as described above, may be integrated into cold chain management for warehouse management in a variety of industries. Each industry may require different temperature, humidity, light environments etc., which may be monitored using a herd wireless network.

According to further embodiments, ultra low complexity wireless networking, as described above, may be integrated into cold chain management for medical transportations, such as specimens, organs, cells, etc. For example, the herd wireless network may be used to ensure that shipment and storage requirements for stem cells, specimens etc. are maintained throughout.

According to further embodiments, ultra low complexity wireless networking, as described above, may be integrated into cold chain management for dangerous goods transportations or hazardous materials, whether solids, liquids, or gases. For example, such materials may include radioactive, flammable, explosive or corrosive materials, oxidizers or asphyxiants, biohazardous, toxic, pathogen or allergen substances and organisms, and also compressed gases and liquids or hot materials, including all goods containing such materials or chemicals that may render materials hazardous in specific circumstances. Infectious Substances, explosive substances, inflammable chemicals etc. For example, the herd wireless network may be used to ensure that shipment and storage requirements for dangerous goods are maintained throughout.

According to some embodiments the truck mode network topology may include, for example, 15 hub slots×15 ranks (narrow). In some embodiments the Warehouse/cooling ship mode may include, for example, 127 hub slots×2 ranks. In various embodiments co-located hubs may be required to handle all the tags, optionally for multiple separate networks (flat). In further embodiments the herd network may support other configurations which are neither narrow nor flat. It is noted that the terms “refrigeration” and “cooling” are used interchangeably throughout the disclosure, similarly, the terms “refrigerator” and “cooling ship” are used interchangeably throughout the disclosure.

According to some embodiments, a leader may be battery operated, wherein, for example, the target current consumption may typically be less than 20 mA for the leader. In mobile configurations, the leader consumption may be, for example, less than 3 mA. In general, the network may conform to FCC part 15 regulations and CE regulations. The network may further have frequency agility. In some embodiments the wireless tags may be disposable. In some embodiments the tags may operate in a low duty cycle and with short intervals, to support future thin batteries with high internal resistance. Other power requirements, duty cycle requirements etc. may be used. According to some embodiments the leader may be powered by an external power source such as a truck battery, ship power supply or warehouse electrical outlet.

According to some embodiments, a herd network may be formed around a hub. When the hub is activated, it is configured to search for available channels to operate. Depending on clear channel availability (from similar networks or other interferers), it may send out a beacon signal. A sensor node may continuously search for nodes, by activating a receiver. A sensor node never transmits, unless it is connected to the network (i.e. to the hub or another sensor node that is directly or indirectly connected to the hub). When a sensor node receives a beacon, the node may start the connection procedure. If the connection procedure is successful, the sensor node remains connected to its father. A father can be either the hub or another sensor node that is connected to the new node. Once the sensor node is connected, its father may allow it to transit beacons.

In some embodiments a network time and frequency management configuration may be used, which may depend on a simple time division scheme which is dependent on the network configuration (e.g. the number of multi-hop levels can be traded for more nodes directly connected to the root node). The network may use a constant interval frame that is divided such that each member has a distinct slot wherein it communicates with its father and its sons. In this way the members are asleep most of the time and wake up only once per frame, while still keeping full connectivity in a multi-hop network.

According to some embodiments, co-located networks may be implemented, using time and frequency parameters. For example, such a network may have a joint sequence of time and channels to minimize/eliminate collisions with co-located networks.

In further embodiments the herd wireless sensor network may use multiple frequency channels and a constant interval frame. For example, several leaders may self arrange so that there is no overlap in using a channel in a certain time. The frequency/time scheme is managed so that each member has a distinct time and frequency channel to use, which is synchronized with the network it belongs to. Each leader may dictate a different frequency/time scheme that does not-overlap the frequency/time scheme of the other leaders.

According to some embodiments, a new member may join the network by following a simple local rule wherein a sensor can join the network if the new member's potential father can accept more sons. This rule is predetermined and substantially does not involve the root node (hub) of the network. In further embodiments there may be no need for special router nodes, since the node algorithm enables each node to acts as a router, meaning that it may relay messages from its son nodes to its father node.

Regarding the configuration to handle barren or childless nodes, according to some embodiments, each node can have at least one son out of n (e.g., 4 or any other number) sons which is a non-barren son, i.e., which can have other nodes connected as sons, and at most (n−1) barren sons.

According to some embodiments, deadlock resolving (e.g. because nearby units are all “fully-booked”) may be accomplished by having the barren sons routinely look for alternative connections that have fewer hops to the root node. Non-barren nodes give up their right to have sons if there is no son connected to them for a predetermined time interval.

Location detection, according to some embodiments, can be achieved by combining relative signal levels received by the nodes and transferred to the root node, and the time of arrival and signal level information gathered by the root node, to determine the estimated location of each node.

According to some embodiments, synchronization time sequence may be used to reduce network detection time. Accordingly, by carefully selecting the time intervals between beacons sent out by the root node and nodes connected to it (directly and indirectly), the network detection time may be reduced. Because the time intervals between beacons has specific qualities, when a node listens at a certain time slot and does not receive and beacon, it can deduce what other timeslot not to listen to. Thus, the time needed to cover all hypothesis of network beacon existence is shorter than the total number of slot times.

According to some embodiments, a method of determining the network topology by assembling discrete information packets from each node is provided. Each node may send out its unique ID, to which each “father” node adds its unique ID. Therefore each such status packet contains the unique IDs of the node and it father. The root node collects all the packets and assembles the complete network topology from the local connectivity information of each node. Any combination of the above steps may be implemented. Further, other steps or series of steps may be used.

According to some embodiments, one or more sensing mechanisms may be integrated into the herd members. Other parameter sensors may be used to enable remote sensing of one or more parameters, for example, temperature for fresh and frozen goods, product integrity for tampering detection, humidity for chemicals, light for tampering, various gasses for safety etc.

TDMA systems are widely used by wireless sensors systems, where a tight power budget is crucial. Due to the repetitive nature of the system timing, and with prior knowledge of the repeatability, it is easy to maintain excellent tracking of the system timing and thus minimize the power consumption. The power consumption minimization stems from the knowledge of the system timing, allowing for the network nodes to “sleep” most of the time and to wake up at the exact time needed to perform data transfer and network sync.

The major drawback of such synchronous system is that by reducing the power consumption, we are essentially reducing the network activity duty cycle, thus making the network more difficult to detect. Basically the more we reduce power consumption by reducing the duty cycle, we are making the network detection time longer.

According to some embodiments, a system and method, including a flooding algorithm or fast network detection algorithm, is provided that significantly reduces the network detection time in a time division multiple access (TDMA) wireless nodes network, by temporarily (for a predetermined time interval and/or intensity) increasing the number of transmissions within the network. So statistically, while preserving substantially the same duty cycle of a network search, the probability for network detection is much higher.

The system and method are particularly useful for networks where the network existence is not assured and the nodes are spending a major part of their lifespan searching for a network. Assuming a group of such nodes is moving within range of a compatible network, the average time for network detection is the average time per node divided by the number of nodes. According to some embodiments, as soon as one of the nodes detects the network, it starts to transmit network beacons on a large number of time slots of the TDMA system. This drastically increases the probability and hence reduces the detection time for a second node in the group to detect a valid network beacon. This second node will likewise transmit beacons on a large number of time slots, which will further reduce the time of the third node to detect the network, and so on. Such a regenerative process reduces the overall time of all nodes to detect the wireless network by several orders of magnitude. It is noted that each node's first phase of network detection is based on a selected level scheme. The nodes are looking for a selected energy level on the channel as a sign for network activity. This first phase is not based on full reception of messages so overlapping of beacons transmitted may be identified as a valid network indication. In general, the system and method described above may enable wireless nodes to change their states in accordance with environmental changes, which in turn enables the wireless nodes to change their behavior (in accordance to their current states). These environmental changes may include (but are not limited to): one node receiving a network beacon or other signal; a change in temperature, humidity and other environmental parameters; a change in position of the node; specific times, specific intervals from sensor activation, or specific intervals from the last connection to a network etc.

In some embodiments the change of the node behavior may contribute to the reduction in time to connect to a network, the reduction in life time energy use of the node, and/or the reduction in the latency of data transfer in a wireless nodes network.

According to an embodiment of the invention, each member or node may integrate at least an element of the fast network detection algorithm, such that when it detects a network signal or request, the algorithm is activated. For example, if a first member loses its connection to a network, it will continue to search for a network. Once a network beacon is detected and the first member is connected and registered to the network, the first member starts to operate the fast network detection algorithm to cause other potential members to detect the network, by sending out large number of beacons over a predetermined time interval. This stream of beacons drastically reduces the network detection time for adjacent members. Once an adjacent member, a second member in this case, detects a valid network beacon message, the fast network detection algorithm for the first member stops its operation. The trigger to the changed activity of the member can also be external conditions like temperature, humidity, vibrations, etc. Such changes may enable the fast network formation in cases such as external scenarios requiring handling by the network.

The fast network detection system and method, according to some embodiments, may be set up to enable wireless communications in high attenuation environments, for example, in a warehouse, shipyard, or refrigeration environment where multiple stacks of containers, pallets, boxes etc. are present. In one example, in an Ad-Hoc network, each sensor constantly looks for a hub or other sensors that can connect it to a hub. The sensors are placed, for example, in the fresh produce or product boxes. The boxes may be placed one on top of the other, for example, in a pallet. In some embodiments there is one tag per pallet, such that when the pallets are moved along the cold chain, from the packing house till the retailer shelves, the sensors will be able maintain an ultra low complexity wireless link, thereby enabling communication of data between multiple sensors in the wireless network, hi such an embodiment the fast network detection algorithm may be applied to enable enhanced network detection, thereby further improving the sensor and tag communications abilities, while maintaining low power consumption.

In a further example, in a multipoint network, the fast network detection algorithm may be applied to enable enhanced network detection, thereby further improving the sensor and tag communications abilities, while maintaining low power consumption. In some examples, sensors for monitoring temperature, product integrity, time intervals, humidity, light etc. may be used. For example, a warning system based ultra low complexity wireless network may be used to monitor the selected storage environment, and alert the driver or monitoring service as to a problematic change in the storage environment. In a further example, the fast network detection algorithm in combination with a herd wireless network may send updated storage environment status updates to a monitoring service to enable tracking of environment status and location status in real time, around the world. The application of the fast network detection algorithm may be used to enhance quality control, safety standards and client service for transporters or handlers of, for example, cold chain goods, transportations of hazardous materials, fresh produce, seafood, dairy, medical materials, livestock, bio industry, flowers etc.

According to some embodiments, at stage one of a fast network detection process, each network node or potential node may monitor, listen or search its surroundings or environment to detect a valid network beacon or signal, or a relevant external condition change. At stage 2, each node may determine when a beacon and/or external change is detected, for example, when a viable signal threshold is reached. At stage 3, a new member (i.e. first) node may perform or execute registration to the network (or to the network leader), to register this new member node to the existing network or the network being formed. During registration, in some examples, the new member may be synchronized to the network timing. At stage 4, a command may be given to the new member node start temporarily transmitting network beacons on a large number of time slots of the TDMA network. Alternatively, the above may be performed in accordance with predetermined conditions. The number of transmissions within the network may be increased for a predetermined time interval and/or intensity.

This will drastically increase the probability and hence reduce the detection time for an additional (i.e. second) node to detect a valid network beacon. At stage 5, the new member or first node will continue to monitor whether it is still connected to the network. Likewise, when the second node detects the network, the second node will likewise temporarily transmit beacons on a large number of time slots, which will further reduce the time of the third node to detect the network, and so on. At the time when the second note detects the beacon or network, the first node may cease its temporarily increased transmission of network beacons. Such a regenerative process reduces the overall time of all nodes to detect the wireless network by several orders of magnitude. It is noted that each node's first phase of network detection may be based on a selected level or scheme, so overlapping of beacons transmitted by various nodes should not cause mutual interference, since overlapping beacons may be identified as a valid network indication without the need to receive a full beacon and to verify the information contained within. In this way, while preserving substantially the same duty cycle of a network search, the statistical probability for network detection is substantially higher.

According to some embodiments, the fast network detection process may be activated upon occurrence of external events or environmental changes. According to some embodiments, network nodes may be configured to listen for network or environmental activity or changes. When such changes are detected by a first non connected node, for example when a signal reception level crosses a certain threshold, the first non connected node may synchronize to the network timing, and perform registration to the network or simply join the network. The first node, which is now connected, may begin temporarily sending out increased network beacons to allow other network nodes to connect to the network.

The first node, which is now connected, may stop the increased beacon sending at a pre-determined time limit or when other members perform registration to the network. Other members detecting the beacons may also send out increased beacons by themselves, thereby enabling the network to be formed or woken up quickly in response to an external event. According to an embodiment of the invention, a method by which a wireless unit that is connected to a wireless network assists fast detection of the wireless network by non connected wireless units. The method may be activated upon occurrence of external events or environmental changes. According to some embodiments, connected network nodes listen for network or environmental activity or changes. When such changes are detected, for example when the temperature or illumination level crosses a certain threshold, the connected node applies a transmit scheme, that is, begins sending out network beacons at increased an rate or duty cycle, also referred to as switching to a high duty cycle of transmission. In doing so, the connected node alerts other non connected wireless units to the presence of the wireless network and to the availability of slots for connection to the wireless network. According to an embodiment of the invention, a search scheme is most often conducted by a wireless unit that is not connected to a wireless network and is searching for a wireless network to connect to.

A search scheme often includes switching the receiver to a higher duty cycle. According to an embodiment of the invention, the transmit scheme is most often conducted by a connected wireless unit when the probability of connecting with non connected wireless units is high, for example, if the wireless unit senses a change in environmental conditions. The transmit scheme often includes switching the transmission to a higher transmission duty cycle.

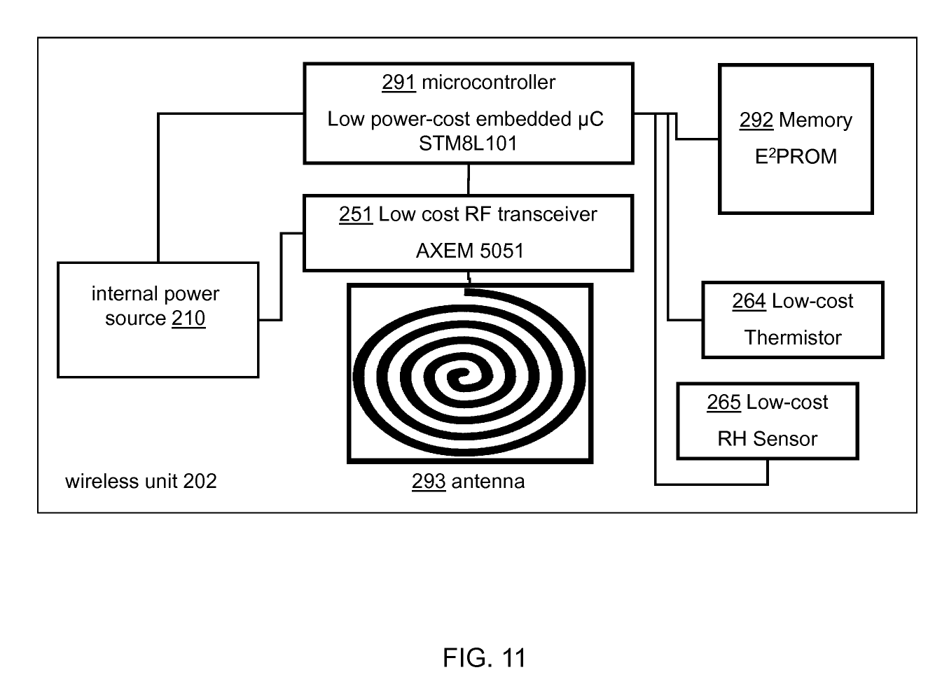

FIG. 11 illustrates wireless unit 202, according to an embodiment of the invention. It is noted that wireless unit 202 may be implemented in the various wireless networks disclosed, and that it may also be implemented as a wireless unit 200 and/or 201 as well. Some components that were already disclosed in relation to wireless unit 200 and/or 201 and which may be implemented in wireless unit 202 according to various embodiments of the invention are not disclosed again.

According to an embodiment of the invention, wireless unit 202 is a low cost wireless unit such as a wireless tag.

Wireless unit 202 may include microcontroller 291, that may be for example a low power-cost embedded [mu]C STM8L101. Microcontroller 291, according to various embodiments of the invention, may implement some or all of the processing functions of the components of previously discussed wireless systems 200 and 201, such as 220, 230, 240, and 270.

Wireless unit 202 further includes low cost RF transceiver 251, such as AXEM 5051. According to an embodiment of the invention, low cost RF transceiver 251 may be configured to implement one or more of the functionalities of transmitter 250. Low cost RF transceiver 251 is connected to an antenna 293, such as a Printed-circuit Antenna.

Wireless unit 202 includes a memory 292, such as an E<2>PROM memory, that is connected to low cost RF transceiver 251.

According to an embodiment of the invention, wireless unit 202 may include a thermistor 264 (which may be a low-cost thermistor). Low-cost thermistor 264 may be used, for example, as a sensor 260.

According to an embodiment of the invention, wireless unit 202 may include relative humidity sensor 265.

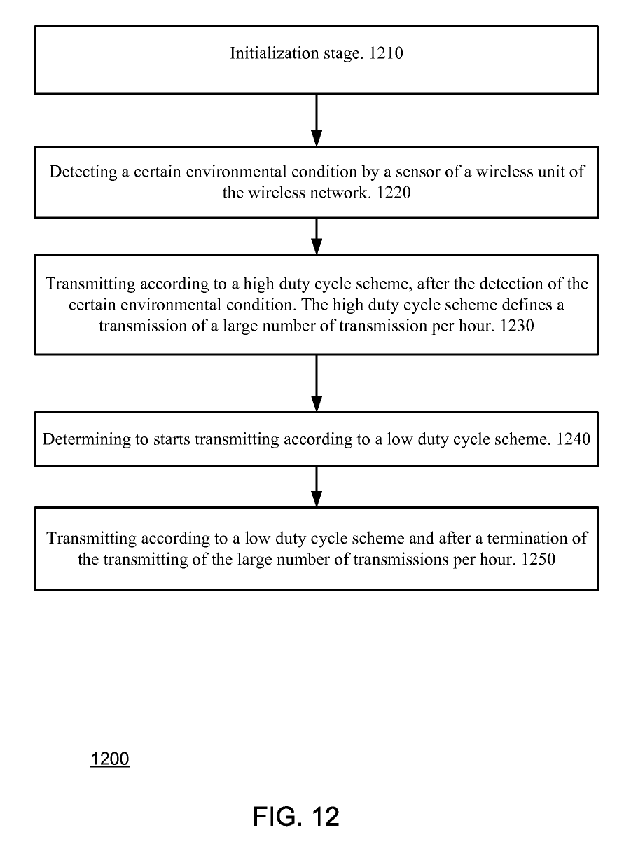

FIG. 12 illustrates method 1200 according to an embodiment of the invention. Method 1200 may include stage 1210, 1220, 1230 and 1240.

Stage 1210 may be an initialization stage. It may include receiving or determining one or more parameters. Stage 1220 may include detecting a certain environmental condition by a sensor of a wireless unit of the wireless network.

Stage 1230 may include transmitting according to a high duty cycle scheme, after the detection of the certain environmental condition. The high duty cycle scheme defines a transmission of a large number of transmissions per hour.

Stage 1240 may include determining to starts transmitting according to a low duty cycle scheme.

Stage 1250 may include transmitting according to a low duty cycle scheme and after a termination of the transmitting of the large number of transmissions per hour. The low duty cycle scheme defines a transmission of a small number of transmissions per hour. Stage 1220 may include obtaining multiple sensor indications from multiple sensors, detecting that a temperature level crosses a predefined temperature threshold or that an illumination level crosses a predefined illumination threshold.

Stage 1240 may include determining to start transmitting according to the low duty cycle scheme in response to at least one of the following: an amount of power available to the wireless unit, to a probability of a detection of at least one other wireless unit of the wireless network, upon a detection that the certain environmental condition ceases to exist, in response to an instruction provide by a leader of the wireless network or a combination thereof.

Stage 1210 may include determining a power of a transmission according to the high duty cycle scheme based on the probability of finding a network. Stage 1210 may include determining the duration of the high duty cycle based on the probability of finding a network.

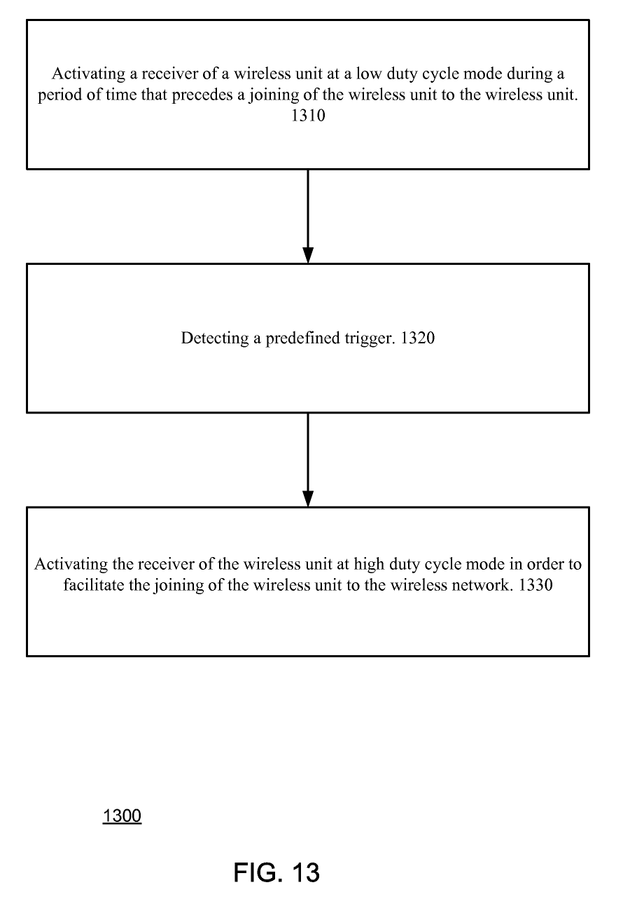

FIG. 13 illustrates a method 1300 according to an embodiment of the invention.

Method 1300 starts by stage 1310 of activating a receiver of a wireless unit at a low duty cycle mode during a period of time that precedes a joining of the wireless unit to the wireless unit. Stage 1310 may be followed by stage 1320 of detecting a predefined trigger. Stage 1320 may be followed by stage 1330 of activating the receiver of the wireless unit at high duty cycle mode in order to facilitate the joining of the wireless unit to the wireless network.

Method 1300 may include activating the receiver of the wireless unit at the low duty cycle mode after joining the wireless unit. Method 1300 may include activating the receiver of the wireless unit at the low duty cycle mode after failing to join the wireless unit. Method 1300 may include activating the receiver of the wireless unit at the low duty cycle mode after an expiration of a predefined period during which the wireless unit failed to join the wireless unit. Method 1300 may include terminating the activating of the receiver of the wireless unit at the high duty cycle mode after the predefined trigger seizes to exist. Method 1300 may include terminating the activating of the receiver of the wireless unit at the high duty cycle mode after an expiration of a predefined period of time after the predefined trigger seizes to exist.

The duration of the low duty cycle may be responsive to a level of available energy of the wireless unit. The duration of the low duty cycle may be responsive to an average time required for joining the wireless network. The detecting of the predefined trigger may be responsive to outputs provided by at lest one sensor of the wireless unit. The predefined trigger may be a predefined change in an illumination that impinges on a light sensor of the wireless unit. The predefined trigger may be a sensing of an acceleration level that exceeds a predefined level.

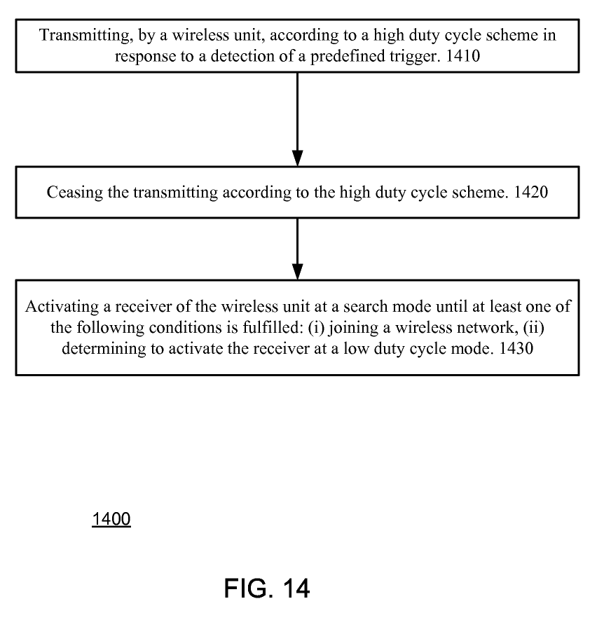

FIG. 14 illustrates method 1400 according to an embodiment of the invention. Method 1400 may include: (a) stage 1410 of transmitting, by a wireless unit, according to a high duty cycle scheme in response to a detection of a predefined trigger; (b) stage 1420 of ceasing the transmitting according to the high duty cycle scheme; and (c) stage 1430 of activating a receiver of the wireless unit at a search mode until at least one of the following conditions is fulfilled: (i) joining a wireless network, (ii) determining to activate the receiver at a low duty cycle mode.

19 The activating of the receiver at the search mode comprises activating the receiver at a high duty cycle mode. The activating of the receiver at the search mode can include activating the receiver at the low duty cycle mode.

According to an embodiment of the invention a method can be provided for assisting fast detection of a wireless network, the method carried out, by a wireless unit can include joining a wireless network; then transmitting according to a high duty cycle scheme, then transmitting according to a low duty cycle scheme.

According to an embodiment of the invention a method can be provided. The method can be for assisting fast detection of a wireless network based on a trigger event, the method carried out by a wireless unit of a wireless network. The method may include at least one trigger that initiates transmission according to a high duty cycle scheme by the wireless unit of a wireless network, then transmitting according to a high duty cycle scheme, then transmitting according to a low duty cycle scheme.

According to an embodiment of the invention a method can be provided. The method can be for an adaptive search by a wireless unit that is not connected to a wireless network, the method can be carried out by a non connected wireless unit and the method can include defining a low duty cycle mode for a wireless unit receiver, defining a high duty cycle mode for a wireless unit receiver, defining at least one trigger that initiates a change in the wireless unit receiver state from a low duty cycle mode to a high duty cycle mode, switching the wireless unit receiver from low duty cycle mode to a high duty cycle mode upon being triggered by the at least one trigger, then joining a wireless network or switching back to a low duty cycle mode for a wireless unit receiver. The method can include switching the wireless unit receiver from low duty cycle mode to a high duty cycle mode upon being triggered by the at least one trigger, for a predetermined duration, switching the wireless unit receiver from low duty cycle mode to a high duty cycle mode upon being triggered by the at least one trigger until the trigger events ends, switching the wireless unit receiver from low duty cycle mode to a high duty cycle mode upon being triggered by the at least one trigger for a predetermined duration after the trigger events ends.

A wireless unit member node can be provided. The wireless unit, while not connected to a network, is constantly searching for a nearby network in order to connect. The search, involves operating a receiver to sense a wireless network transmission, which consumes power from the member power supply. Since wireless unit members are usually battery powered the search mode is designed to minimize power consumption, which results in a longer detection time of an available network in range. In some cases, based on external events, a member node will switch to an increased search mode, which involves operating the member node's receiver at a higher duty cycle than in normal mode, the low duty cycle mode for a wireless unit receiver. The events can be temperature change, illumination change, mechanical vibrations and others. Those events are in high correlation with the existence of a wireless network in range, and will result significantly faster network detection times.

According to an embodiment of the invention, a low duty cycle mode is defined for the receiver. A duty cycle that will conserve power while enabling an effective search for a near proximity network. In some cases this duty cycle is based on available energy in the sensor units power source and the average time needed for network detection.

According to an embodiment of the invention a high duty cycle is defined for the receiver. The high duty cycle is used in situations where it is anticipated that the probability of finding a network is high, that is trading off power consumption for an anticipated shorter network detection time. In some embodiments, the duty cycle can be made as high as possible for a duration, as long as possible, given the confidence that the external event, triggering the duty cycle increase, is indeed a good indication to the existence of a sensor network in range. The high duty cycle is applied or triggered upon the occurrence of a predefine event or sensor reading, for example a significant change in light levels, high acceleration or larger then defined tilt. The high duty cycle mode is often applied for a limited, predetermined duration, in that the power requirements during the high duty cycle is high and cannot, usually, be supported, power wise, for a long duration.

In some embodiments, the duration may be adaptively determined by the unit's power level.

In some embodiments, the duration may be adaptively determined the trigger type in that different triggers may be indicative of different probability levels of finding a network. In some embodiments, the duration may be adaptively for the duration of the trigger event or for a predetermined duration after the trigger event ends. For example a change in illumination levels, i.e. exposure to light or a sudden change on temperature can indicate that the shipping container or the trailer has been opened, which could indicate the arrival at the destination. Such events can trigger the receiver to search for nearby networks at a high duty cycle for a predetermined duration, e.g. 1-5 minutes.

In another embodiment, if the power level is less than 30% of the original power level, the high duty cycle duration will be reduced to 50% of the original duty cycle duration. In another embodiment, the high duty cycle duration will be proportional to the amount of power remaining for example, if the power level is 60% of the original power level, the duty cycle duration will be 60% of the original duty cycle duration. In another embodiment, the receiver will cease searching for nearby networks using a high duty cycle if the trigger condition ends, e.g. light or temperature conditions returned to pre event levels, for example of the container door was opened for a short duration and then closed.

According to an embodiment of the invention a non connected wireless unit can sense a trigger, switches to a transmit scheme i.e. a high rate transmission scheme (“yells, wake up everybody”) and then switches to a search scheme, i.e. a high rate receiving scheme (“anybody out there?”).

According to an embodiment of the invention a method can be provided for assisting fast detection of a wireless network, the method can be carried out, by a wireless unit. The method may include defining at least one trigger that initiates transmitting according to a high duty cycle scheme, then transmitting according to a high duty cycle scheme, then ceasing transmission and switching the wireless unit receiver to a search mode and then joining a wireless network or switching back to a low duty cycle mode for a wireless unit receiver. The search mode can be a high duty cycle search mode or a low duty cycle search mode.

According to an embodiment of the invention a non connected wireless unit, upon sensing change in environmental conditions or due to a network event also known as a trigger events, applies a transmit scheme, i.e. starts transmission at a high duty cycle scheme. The transmissions alert other nearby wireless units that the probability of detecting a nearby wireless network is high. After a short duration, in-order to conserve power switches the receiver to a high duty cycle search mode. The increase in transmissions by multiple wireless units increases the probability of starting a chain reaction wherein wireless units, that are for example nearby to units of a wireless network, will be able to connect to the network, thereby increasing the range of network connectivity enabling the connection of additional units, and so on.

The wireless unit will either join a network or switch back to a low search mode that is typical for a non connected wireless unit.

According to an embodiment of the invention there are provided low complexity wireless networks and specifically low complexity wireless networks that may reconfigure the low complexity wireless network topology (for example—periodically) and may apply methods to establish the low complexity wireless network (i.e. connect all of the wireless units to the low complexity wireless network) and to do so according to certain topology indexes (e.g. time to form the low complexity wireless network, maximum latency, minimum total energy consumption, etc.).

There are provided methods that produce low complexity wireless network topologies that can provide reliable transfer of data from wireless units to the low complexity wireless network leaders, utilizing the available bandwidth effectively and with minimal energy requirements in-order to provide low complexity wireless network longevity.

The wireless network has a wireless network leader and multiple wireless units that are arranged in a hierarchical manner. The hierarchy levels are also referred to as ranks and both terms are used interchangeably throughout the disclosure. Each wireless unit has a father. The father of the wireless units of the first rank is the wireless network leader. Each wireless unit of the first rank may be (based upon its configuration) a father of a wireless unit of the second rank, and so on

Low complexity wireless network performance quality can be defined by various criteria, including:
a. The speed in which a low complexity wireless network can be established—the speed or time required to establish a low complexity wireless network, includes a variety of parameters such as the time required to connect the first sensors to the root node, e.g. the first rank in the low complexity wireless network hierarchy, the rate at which additional nodes are being connected, e.g. 2^{nd} and 3^{rd} ranks in the low complexity wireless network hierarchy and the time to reach steady state in which there are minor fluctuations in the low complexity wireless network topology.
b. An efficient use of the available bandwidth to enable frequent sampling and data transmission by the low complexity wireless network units.
c. Low complexity wireless network longevity, or efficient use of the available energy in each unit to enable frequent sampling and data transmission—if some of the low complexity wireless network nodes are overtaxed in receiving and transmission tasks, they will have to resort to increasing the duration between measurements and transmissions. In such a case, the weakest links affect the overall low complexity wireless network performance. Furthermore, the system will become unbalanced with respect to the capability of different branches to send reports at the same frequency.
d. The ability to connect to as many nodes as possible.
e. Low complexity wireless network robustness—wherein the number of erroneous transmissions, that require retransmissions is minimized.
Erroneous transmissions could be the caused by many factors, including: incomplete transmissions, transmissions that were disrupted by external RF activity. Retransmissions require additional energy and bandwidth. The reasons there are errors requiring retransmissions can be analyzed and a corrective action can be implemented, e.g. when there is interference, the node can be redirected to a better connection without or with less interference

Each and every variable, by itself, or in conjunction with other variables, at specific times, may define the low complexity wireless network performance quality. A change in low complexity wireless network performance quality may trigger a need to change the low complexity wireless network topology by changing node management rules.

In one embodiment of a low complexity wireless network that includes wireless sensors, initially, the low complexity wireless network is established while the wireless sensors are being deployed and its configuration will be primarily dependent on the sequence in which the wireless units are being deployed. However, this may not be the desired low complexity wireless network topology for a reliable transfer of data from all of the sensors to the low complexity wireless network leader. There may be an opportunity to reconfigure the topology for a specific application and or situation.

Furthermore, over time, there may be a need to reposition the location of a some of the low complexity wireless network sensors, within the network topology, for example if there are environmental changes (either fast—like a door opening and or closing or slow, like building of a new wall in a warehouse).

At any point in time, a wireless unit's state can be defined as either authorized or unauthorized. It status will then be one of:
a. Unauthorized and empty—a wireless unit that currently is not authorized to connect sons and has no sons.
b. Authorized and full—a wireless unit that is authorized to connect sons and has a maximal allowable number of sons—it is authorized to be connected to N sons and has N sons.
c. Authorized and not full—a wireless unit that is currently authorized to connect sons, and has free slots to connect wireless units as sons. It has less than N sons.
d. Unauthorized and not empty—a wireless unit that currently is not authorized to connect sons and has sons—it was authorized in the past, connected to sons, and its authorization state was redefined.

It is noted that the status of wireless network can change from time to time.

For example, an authorized unit was authorized to connect N=4 sons, e.g. based on the number of time slots it was allocated. If at a certain time it connected 2 sons, its status is therefore, “authorized and not full”, if it later connected two additional sons, to a total of 4, it will become full and its status will be “authorized and full”. If at the time it had 2 sons, its authorization state was redefined to be “unauthorized”, its status will be “unauthorized and not empty”.

The wireless network will also include a wireless network leader, also referred to as network root node or gateway. It may have all of the capabilities and functionalities of a father. In some cases it may have additional capabilities and functionalities

Designating initial wireless unit status—a father will designate a portion of its son units (at least one) to be authorized wireless units and the remaining sons to be not-authorized units. not-authorized wireless units may be allocated less communication bandwidth.

In one scenario, an authorized and not full wireless unit, capable of connecting sons of its own (grandchildren to the father) can be the last son to that father, i.e. the N wireless unit the father connects to, that defines the father full.

In this scenario, the low complexity wireless network structure will develop a relatively flat structure and the newly appointed authorized (and not full) son does not compete with its father when connecting additional nodes. However, in this scenario, there is a possibility that the forming of the network structure will advance relatively slower.

In a second scenario, each father will define his first son, i.e. the 1st wireless unit the father connects to, to be authorized. In this scenario, the network structure will develop a relatively deep structure with many ranks. In this scenario, the father and son compete in the same area, to connect additional nodes and the initial stages of forming the network structure will advance relatively rapidly.

When the low complexity wireless network topology dynamically changes, there might be a need to assign more bandwidth to certain parts of the network. This can be done by defining the state of sensors in certain sections of the network to become unauthorized, while defining the state of other sensors to become authorized

This capability enables the network to assign communication bandwidth to the nodes which have more potential son nodes in range. This capability is applied based on a predefined rule set, for example:
a. “The network should strive to have a balanced topology”—a network wireless network leader or a father to a few levels within the network hierarchy determines that the network below him is unbalanced, e.g. that there is a concentration of sensors that are authorized and full while other sections of the network have many authorized sensors that are not full—that have no sons, or have only one or two sons.
b. “The network strives to be flat”—in most cases, it is preferable to have a flat network with a minimal number of ranks within the hierarchy. A flatter network topology requires less transmission hops, saves network power and is more reliable.
c. “The network should be narrow and deep”—in some cases, e.g. in a container or truck, it is preferable to have a narrow and deep network with a large number of ranks within the hierarchy. The network owner will define this rule. In this scenario, the network wireless network leader or a father to a few levels within the network hierarchy can change the state of an authorized sensor to that of unauthorized, when it has reached the half full mark (e.g. N/2) so that the network will expand in depth, evenly and rapidly

State and status changes—from authorized to unauthorized or from unauthorized to authorized as well as from full or not full to empty and vise versa.

All these state changes can be initiated by the father of the wireless unit whose status is being changed or by the wireless network wireless network leader. A wireless unit can also initiate a change of its status from authorized to unauthorized and from full or not full to empty.

Changing the status of a wireless unit from authorized to unauthorized—the status of an Authorized wireless unit can be changed to that of an unauthorized wireless unit. The change may be initiated by the father, by the network wireless network leader (gateway) and or by the wireless unit itself. The change can be triggered due to a variety of occurrences, for example:
a. Due to an instruction by its father, that has determined that the son wireless unit does not meet predefined criteria governing sons of the father.
b. Due to an instruction from the network wireless network leader, transmitted via the father.
c. The wireless unit may “decide”, based on a set of predefined criteria, that it must stop allowing additional sons.

The father may initiate the change of an authorized wireless unit to that of an unauthorized wireless unit based on, for example, a “max time to connect to sons” rule, in which a father that monitors the authorized son wireless unit performance with respect to connecting of additional grandchild wireless units. If the authorized son wireless unit does not achieve this task in a specified time interval, the father will change the authorized son wireless unit status to that of an unauthorized wireless unit and transfer the right to connect grandchild wireless units, i.e. the authorization, to a second son that is an unauthorized wireless unit. In doing so, the father may change the status of two sons—the first from authorized to unauthorized and the second from unauthorized to authorized.

The time interval can be pre-determined and set in the wireless units as part of a rule set. In some cases it can be dynamic for example, as a function of power levels or based on the number of hops to reach the wireless network leader, such that a wireless unit, further away from the gateway, will be allocated more time to attract grandchild wireless units than wireless units that are “closer”.

The wireless network leader may initiate the change of an authorized wireless unit to that of an unauthorized wireless unit based on, for example, the “simplify network topology” rule, in which a wireless network leader detects a congestion of nodes, wherein a large number of nodes are connected to the wireless network leader via few son nodes, and affecting the network data transfer effectiveness. In such cases, the wireless network leader may strive to “flatten” the network. By making some nodes unauthorized, in doing so, the wireless network leader forces nodes to search for alternative connections that might facilitate a flatter network.

A wireless unit may initiate the change from an authorized wireless unit (that is allowed to connect sons), to that of an unauthorized wireless unit, that is not allowed to connect additional sons, based on, for example, the “minimal power conservation rule”, in which a wireless unit with minimal power resources will refrain from connecting additional wireless units as sons. The wireless unit will convey to its wireless father unit wireless unit that it is incapable (based on the above rule) to connect additional sons and will declare itself unauthorized.

The wireless father unit or wireless network leader may change the state of other wireless units to that of authorized, in order to apply the available bandwidth, or choose to overrule the decision made by the individual sensor.

Changing the status of a wireless unit from unauthorized to authorized—The status of an unauthorized wireless unit can be changed to that of an authorized wireless unit. The change may be initiated by the wireless father unit wireless unit or by the network wireless network leader (gateway), via the wireless father unit.

The wireless father unit, that is changing its sons status from that a not-authorized wireless unit to that of an authorized wireless unit may further define the “authorization” state, e.g. authorizing the son to connect M sons of his own (grandchildren to the wireless father unit), wherein M is different than N.

Changing the status of a wireless unit from unauthorized and empty to authorized—The status of an unauthorized and empty wireless unit can be changed to that of an authorized wireless unit. The change may be initiated by the wireless father unit wireless unit or by the wireless network leader (gateway), via the wireless father unit.

The status of the authorized son may take on different forms:

1) Authorized and not full—the wireless unit whose state has changed, has no sons of its own. It is authorized to connect sons of its own.

In another scenario, the wireless father unit may connect grandchildren from another son, to the son whose status is changing, however, the number of sons connected is less then N and therefore the son is not full. The wireless father unit may do so, for example, in-order to flatten the network.

2) Unauthorized and not empty—the wireless unit whose status has changed, has sons of its own, hence it is not empty. Its state has changed to be unauthorized because: a) it has not added new sons fast enough; this change may be triggered autonomously or by an instruction from the wireless father unit or gateway; or b) the network is not balanced and there is a need to add sons (some times referred to as nodes) in other parts of the network, this change may be triggered by an instruction from the wireless father unit or gateway

In another scenario, the wireless father unit may connect grandchildren from another son, to the son whose status is changing, however, the number of sons connected is less then N and therefore the son is not full. The wireless father unit may do so, for example, in-order to flatten the network.

3) Authorized and full that is, connected to N number of sons. In this scenario, the wireless father unit may connect N grandchildren from another son, to the son whose status is changing, and this son will immediately be full.

Changing status to that of unauthorized and empty, (from other statuses)—The status of a wireless unit can be changed to that of an unauthorized and empty wireless unit. The change may be initiated by the wireless father unit, by the wireless network leader (gateway) and by the wireless unit itself. The change can be triggered due to a variety of occurrences, for example: 1) due to an instruction by its wireless father unit, that has determined that the network below him, will be better served if that son wireless unit will be unauthorized and empty, or 2) similarly, due to an instruction from the network wireless network leader, transmitted via the wireless father unit, and 3) the wireless unit may “decide”, based on a set of predefined criteria, that it cannot “support” any sons.

The wireless father unit may initiate the change of a wireless unit (that is authorized and full or not full) to that of an unauthorized and empty wireless unit based on, for example, the “max time to connect sons” rule, in which a wireless father unit wireless unit that monitors the authorized son wireless unit performance with respect to connecting of additional grandchild wireless units.

If the authorized son wireless unit does not achieve this task in a specified time interval, the wireless father unit wireless unit will change the authorized son wireless unit status to that of an unauthorized and in the process might also change its status to unauthorized and empty.

The wireless network leader may initiate the change of a wireless (that is authorized and full or not full) to that of an unauthorized and empty wireless unit based on, for example, the “simplify network topology” rule, in which a wireless network leader detects a congestion of nodes, where large number of nodes are connected to the wireless network leader via few son nodes, affecting the network data transfer effectiveness. The wireless network leader may strive to “flatten” the network. By making key nodes unauthorized and empty, the wireless network leader will force nodes to search for alternative connection that might facilitate a flatter network.

The wireless unit that is authorized and full or not full may initiate the change to that of an unauthorized and empty based on, for example, the “minimal power to shut down”, in which a wireless unit with minimum power resources will use all of its available power for an orderly shutdown procedure. This procedure may include informing the wireless father unit of its power status so that he can transfer the wireless units sons (the wireless father units grandchildren) to a different son.

The following tables describes possible non-limiting scenarios:

Wireless father unit applies the “max time to connect sons” rule, on Son #1, at t=2

| t = o | | t = 1 | t = 2 | | Comments |
|---|---|---|---|---|---|
| Wireless father | | | | Wireless father | |
| unit defines | | | | unit defines | |
| Son #1 | authorized | Is connecting | Is not | unauthorized | Disconnects all |
| (That is not | | grandchildren | connecting | | grandchildren |
| full) | | at the minimal | grandchildren | | |
| | | rate | at the | | |
| | | | minimal rate | | |
| | | has 2 sons | has 2 sons | has 0 sons | |

| | | | |
|---|---|---|---|
| Son #2 | unauthorized and empty | authorized and | Starts network |
| | | not full | below, from |

| | |
|---|---|
| has 0 sons | scratch |

| | |
|---|---|
| Son #3 & #4 | unauthorized and empty |

Wireless father unit applies the “max time to connect sons” rule, on Son #1, at t=2, but does not affect grand children connected to Son #1

| t = o | | t = 1 | t = 2 | | Comments |
|---|---|---|---|---|---|
| Wireless father | | | | Wireless father | |
| unit defines | | | | unit assigns | |
| Son #1 | authorized | Is connecting | Is not | unauthorized | Maintains Son |
| (That is not | | grandchildren | Connecting | | #1 network |
| full) | | at the minimal | grandchildren | | |
| | | rate | at the | | |
| | | | minimal rate | | |
| | | has 2 sons | has 2 sons | has 2 sons | |

| | | | |
|---|---|---|---|
| Son #2 | unauthorized and empty | authorized and | Starts network |
| | | not full | below, from |
| | | has 0 sons | scratch |

| | |
|---|---|
| Son #3 & #4 | unauthorized and empty |

Son #1, which is an authorized and not full, autonomously applies the “minimal power conservation rule”, at t=2, and becomes an unauthorized and not empty. Wireless father unit “transfers” the Authorization to Son #2.

| t = o | | t = 1 | t = 2 | | Comments |
|---|---|---|---|---|---|
| Wireless father | | | | Autonomously | |
| unit defines | | | | declares himself | |
| | | | | unauthorized, | |
| | | | | Wireless father | |
| | | | | unit “transfers” | |
| | | | | Authorization | |
| | | | | to Son #2 | |
| Son #1 | authorized | Is connecting | Is low | unauthorized and | Maintains all |
| (That is not | | grandchildren | on power | not empty | connected |
| full) | | at the minimal | | | grandchildren |
| | | rate | | | |
| | | has 2 sons | has 2 sons | has 2sons | |

| | | | |
|---|---|---|---|
| Son #2 | unauthorized and empty | authorized and not | Starts connecting |
| | | full | sons, |

| | |
|---|---|
| Son #3 & #4 | unauthorized and empty |

In one embodiment, a wireless father (that may also be a wireless network leader) can be arranged to:
a. Defines at least one son, typically starting with the first wireless unit that has connected (son #1), to be an authorized wireless unit and assigns additional sons to be unauthorized wireless units.
b. Checks authorized son (son #1) rate of adding grandchildren to the network.
c. If rate meets or accedes a predefined value—the authorized son (son #1) status remains as is, until it can becomes full.
d. If rate is below a predefined value:
   i. The wireless father unit will redefine the authorized son (son #1) state to an unauthorized wireless unit.
   ii. In parallel, the wireless father unit will define the state of another son (e.g. son #2) to be an authorized wireless unit.
   iii. If the first son (son #1), had sons of its own, that wireless father unit may
      1. Keep them connected to son #1—making son #1 unauthorized and not empty.
      2. Transfer them to son #2—making son #2 an authorized and not full with at least one son.
      3. Release them from the network, in which case, son #1 will become unauthorized and empty and the sons will try and reconnect again to new wireless father units, and
      4. Transfer them to another son, e.g. son #3, making son #3 unauthorized and not empty.

In some cases, the optimal performance will be achieved by establishing a balanced network with respect to the network hierarchy, i.e. the number of layers. In some cases the preferred topology will be that of a ladder.

In some cases, wireless father unit wireless unit may sense that the network is expanding faster in a specific area of the network, and in order to allow for faster network establishment with the most nodes, the wireless father unit will direct bandwidth to that area of the network by changing the status of unauthorized and empty wireless units in the faster growing area to that of authorized wireless units.

Similarly, in some cases the wireless father unit will change the state of unauthorized and empty wireless units that are in proximity to a very productive son, to that of authorized wireless units, and (try to) transfer grandchildren wireless units of the productive son to the new authorized wireless units.

In some cases it is advantageous to change the state of unauthorized and empty wireless units to that of authorized wireless units attempting to resolve possible deadlocks. Deadlocks being unconnected wireless units that are close to the network but cannot find a wireless father unit, possibly because all the nearby potential wireless father units are unauthorized or authorized and full.

When establishing a new network, or when “re-shuffling the deck”, i.e. everyone starts looking for new partners (wireless father units).

In one embodiment—In order to solve a problem wherein the network hierarchy may become unnecessarily complex, for example, in a “preferred” hierarchy structure the sensors that are in close proximity to the gateway, will be connected to the gateway (1^{st} layer) and sensors that are further away, will be connected to the 1^{st} layer, etc.

However, in some cases, it may happen that sensors in close proximity to the gateway will find other close proximity sensors to connect to, in effect making the network un-necessarily complex.

A solution to the above problem—by creating time bands in which only specific layers can be connected to, i.e.

Assuming the re-shuffling starts at time=t0.

The gateway, is allowed to connect to N wireless units, e.g. 24 wireless units.

During the first time band (t0-t1) only the gateway can connect sons.

That is the gateway is given a better chance of filling its 24 allocated sons slots and the complexity described above will have a lesser probability of occurring.

In time band t1-t2, only first layer sensors are allowed to connect sons.

Wireless Unit Identifiers

In one embodiment, each wireless unit (sensor) is identified by two identifiers (IDs). An original ID that is “given” to him when he was manufactured and a second ID which can be referred to as a network “family” name. The network family name is given to the sensor, by its wireless father unit, upon connecting with the wireless father unit and joining the network. The network family name is composed of the wireless father unit's family name and an additional digit identifying—which number son, the wireless unit is, to its wireless father unit.

Each wireless unit may be given a number identifying it, in the order in which it connected. The first son to connect is wireless unit #1, the second is wireless unit #2, the twelfth son is wireless unit number 12 etc. Sons that are connected to the gateway are different then other wireless units in that they may have many siblings, while lower ranking wireless units have n siblings, wherein n is less than 9, e.g. is each authorized wireless unit is allowed to connect up to n=4 sons.

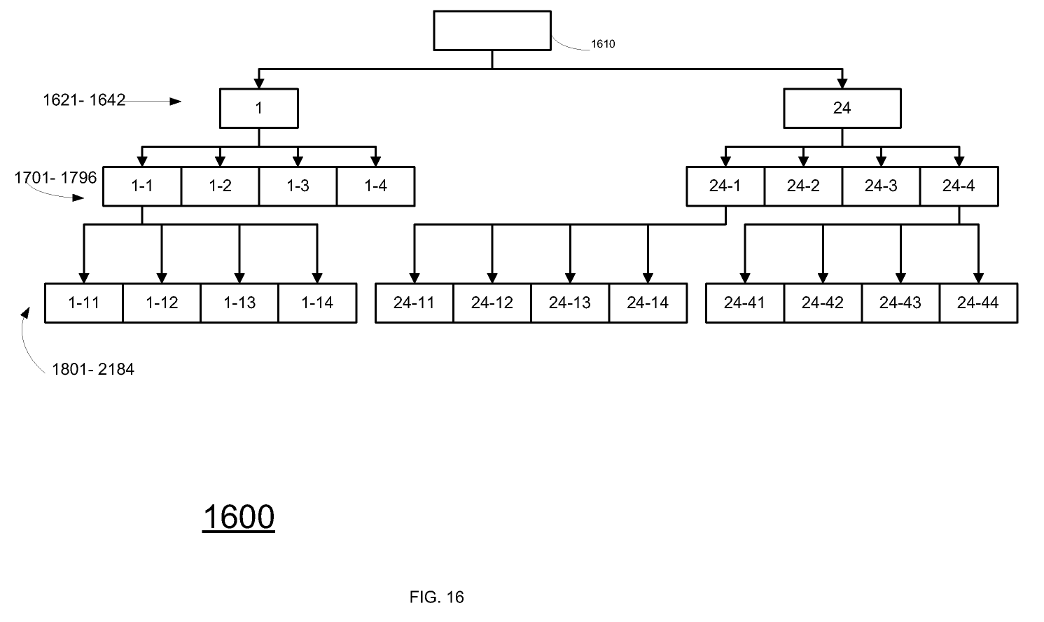

The network family name identifies how the network branch is connected to the gateway. The length of the number identifies how far, i.e. how many connections, that wireless unit has to connect to the gateway. The first digit(s) identifies the highest level wireless unit in the branch, the wireless unit that is connected directly to the gateway. This digit(s) is separated by a hyphen from the rest of the network family name. The next digit identifies the order of the sons to that wireless father unit, etc. this is best explained by way of example and reviewing FIG. 16.

For example, wireless unit #14-321 is connected to a branch of the network that originates from the 14^{th} wireless unit to connect to the gateway. Its grandfather unit is the 3^{rd} son to connect to wireless unit #14. Its wireless father unit is the 2^{nd} wireless unit to connect to wireless unit #14-3. It is the first wireless unit to connect wireless unit #14-32.

For example, assuming that the wireless network has four levels, that each authorized wireless unit is associated with sons and that the gateway can have up to N=24 sons, that is, it forms 24 first level wireless units denoted 1 to 24.

Each first level wireless unit may have up to four second level sons denoted 1-1 till 24-4.

The four second level sons of first level son 1 are denoted 1-1 till 1-4, according to the timing (order) of the association between them and first level son 1.

The four second level sons of first level son 24 are denoted 24-1 till 24-4, according to the timing (order) of the association between them and first level son 24.

Each second level son can have up to four third level sons denoted 1-1 till 24-4.

The four third level sons of second level son 1-1 are denoted 1-11 till 1-14, according to the timing (order) of the association between them and second level son 1-1.

The four third level sons of second level son 24-1 are denoted 24-11 till 24-14, according to the timing (order) of the association between them and second level son 24-1.

FIG. 16 illustrates network 1600 having a wireless network leader 1610, twenty four first level wireless units 1621-1642, ninety six second level wireless units 1701-1796 and three hundred and eighty four third level wireless units 1801-2184.

Some of these wireless units are drawn with their identifiers—first level wireless unit identifiers 1, 2 and 24, second level wireless unit identifiers 1-1, 1-2, 1-3, 1-4, 24-1, 24-2, 24-3 and 24-4, and third level wireless unit identifiers 1-11 and 24-44.

If, for example, second level wireless unit 24-1 may have four sons but it currently has three sons then it is not-full. If, it has all four sons then it full. Although FIG. 16 illustrates all first and second level wireless units as having sons this is not necessarily so and some can be without sons—either being authorized or unauthorized.

Yet for another example—the gateway may be configured to increase the number of sons connected to it in order to form a flatter hierarchy.

Each first level son, reports to the gateway upon the connection of another wireless unit below it, be it a son or grandson, etc.

The gateway monitors the size of the hierarchies below the first level sons, (the total number of grandchildren, grand grandchildren, etc. per first level son) at every predefined cycle duration (for example T=1000 msec) and applies an algorithm (such as the below) to monitor the network structure and mange its topology, for example, to make it flat: if son S has the smallest hierarchy below, equal to p wireless units, and if son R has more than double (2×p) wireless units—then, in one embodiment, the gateway redefines R's state and status to be unauthorized and empty and defines U's state (another first level wireless unit) to be authorized so that all of the hierarchy below R will be disconnected and start looking for new wireless father units.

Yet for a further example—A gateway is configured in a warehouse. A network is functioning in the warehouse connected to the gateway. A truck delivers and unloads pallets in the warehouse, potentially doubling the network size. As the new wireless units connect to the network, it becomes unbalanced with multiple levels in the area of the “new sensors” and fewer levels in other areas. This is a potential problem in that the network is not balanced energy wise. Some wireless units are overtaxed with a need to transfer information of many levels while other wireless units are not fully utilized. The life time of the network as a whole will be shorter.

In one embodiment, the wireless network exploits the gateway's ability to identify this unbalance, from the transmissions forwarded to it by newly arrived sensors, in that each transmission includes the sensors ID: its original ID and the network family ID. A long ID number defines many levels in the hierarchy. If the gateway identifies that the number of levels, in a multiple branches (e.g. in a ¼ of the total number of network branches, where in a network branch is a connection to the gateway), is over 2× the number of levels in the shortest branch, the gateway will disconnect ALL of its branches and reform the network from scratch.

Yet for an additional example—A wireless father unit 1-1 connects first son 1-11. As part of the connection transaction the wireless father unit defines 1-11 as authorized, records the time stamp, t=t0 (1-11) of the connection, records status of downstream hierarchy connected to it, i.e. number of sons=1, number of grandsons=0 etc.

Wireless unit 1-11, is authorized to connect n=4 wireless units, of which the first wireless unit (wireless unit 1-111) will be an authorized and within a predetermined period (for example T=1000 msec) after of t=t0(1-11) and to report to its wireless father unit upon each connection, within a portion (for example 100 msec) of the connection.

At the end of the predetermined period (at time T=1000 msec), the wireless father unit asses status of downstream hierarchy connected to it.

If wireless unit 1-11 has less than four reported connections, wireless father unit wireless unit will re-defines wireless unit 1-11 state and status to be unauthorized and empty and re-defines wireless unit 1-12 as authorized, and able to connect n=4 wireless units.

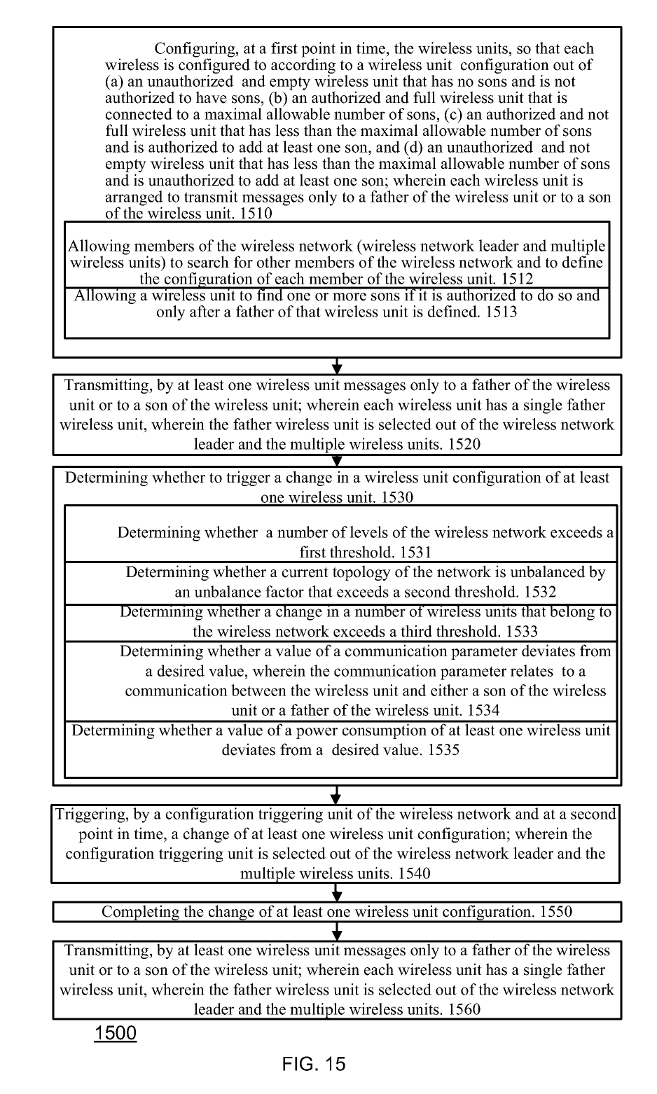

FIG. 15 illustrates a method 1500 for operating a wireless network, according to an embodiment of the invention.

The wireless network includes a wireless network leader and multiple wireless units.

Method 1500 may start by stage 1510 of configuring, at a first point in time, the wireless units, so that each wireless is configured to according to a wireless unit configuration out of (a) an unauthorized and empty wireless unit that has no sons and is not authorized to have sons, (b) an authorized and full wireless unit that is connected to a maximal allowable number of sons, (c) an authorized and not full wireless unit that has less than the maximal allowable number of sons and is authorized to add at least one son, and (d) an unauthorized and not empty wireless unit that has less than the maximal allowable number of sons and is unauthorized to add at least one son.

Stage 1510 may include stage 1512 of allowing members of the wireless network (wireless network leader and multiple wireless units) to search for other members of the wireless network and to define the configuration of each member of the wireless unit.

Stage 1512 may include stage 1513 of allowing a wireless unit to find one or more sons if it is authorized to do so and only after a father of that wireless unit is defined.

Stage 1512 may include configuring the wireless units to find sons in a gradual manner in which (a) during a first time window the wireless network leader is allowed to find other wireless units (first level wireless units) and define them as his sons, (b) during a second time window authorized and non-full first level wireless units are allowed to find other wireless units (second level wireless units) and defined them as their sons, and so on—during the k'th time window authorized and non-full (k−1)'th level wireless units are allowed to find other wireless units (k'th level wireless units) and defined them as their sons.

The time windows may partially overlap, may be non-overlapping and the like. The k'th time window may be opened after the first till (k−1)'th time windows are opened.

The number of levels of the wireless network can be substantially equal to a length of a longest sequence of father and sons, starting from the wireless network leader.

Stage 1510 is followed by stages 1520 and 1530.

Stage 1520 includes transmitting, by at least one wireless unit messages only to a father of the wireless unit or to a son of the wireless unit; wherein each wireless unit has a single father wireless unit, wherein the father wireless unit is selected out of the wireless network leader and the multiple wireless units. Stage 1520 may include operating the wireless network and allowing an exchange of information to and from the wireless network leader. Messages that do not originate from the wireless network leader may be aimed to the wireless network leader.

Stage 1530 includes determining whether to trigger a change in a wireless unit configuration of at least one wireless unit. If it is determined to change at least one wireless unit configuration then stage 1530 is followed by stage 1540, else stage 1530 may be followed by itself.

Stage 1540 may include triggering, by a configuration triggering unit of the wireless network and at a second point in time, a change of at least one wireless unit configuration; wherein the configuration triggering unit is selected out of the wireless network leader and the multiple wireless units.

Stage 1550 may be followed by completing the change of at least one wireless unit configuration.

Stage 1550 may be followed by stage 1560 of transmitting, by at least one wireless unit messages only to a father of the wireless unit or to a son of the wireless unit; wherein each wireless unit has a single father wireless unit, wherein the father wireless unit is selected out of the wireless network leader and the multiple wireless units. Stage 1570 may include operating the wireless network and allowing an exchange of information to and from the wireless network leader. Messages that do not originate from the wireless network leader may be aimed to the wireless network leader.

The stages of this method may be repeated multiple times—at different point in time. Each configuration change can be triggered by an event (for example—a congestion of nodes or, an unbalanced network) or per predetermined period.

Stage 1530 can include either one of the following or a combination thereof:
a. Stage 1531 of determining whether a number of levels of the wireless network exceeds a first threshold.
b. Stage 1532 of determining whether a current topology of the network is unbalanced by an unbalance factor that exceeds a second threshold.
c. Stage 1533 of determining whether a change in a number of wireless units that belong to the wireless network exceeds a third threshold.
d. Stage 1534 of determining whether a value of a communication parameter deviates from a desired value, wherein the communication parameter relates to a communication between the wireless unit and either a son of the wireless unit or a father of the wireless unit.
e. Stage 1535 of determining whether a value of a power consumption of at least one wireless unit deviates from a desired value.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A wireless network, comprising a wireless network leader and multiple wireless units;
wherein each wireless unit has a single father wireless unit, wherein the father wireless unit is selected out of the wireless network leader and the multiple wireless units;
wherein each wireless unit is arranged to be configured according to a wireless unit configuration selected out of a group consisting of:
(a) an unauthorized and empty wireless unit that has no sons and is not authorized to have sons,
(b) an authorized and full wireless unit that is connected to a maximal allowable number of sons,
(c) an authorized and not full wireless unit that has less than the maximal allowable number of sons and is authorized to add at least one son, and
(d) an unauthorized and not empty wireless unit that has less than the maximal allowable number of sons and is unauthorized to add at least one son;
wherein each wireless unit is arranged to transmit messages only to a father of the wireless unit or to a son of the wireless unit;
wherein a configuration triggering unit of the wireless network is arranged to trigger a change of at least one wireless unit configuration; wherein the configuration triggering unit is selected out of the wireless network leader and the multiple wireless units.

2. The wireless network according to claim 1, wherein the configuration triggering unit is the wireless network leader.

3. The wireless network according to claim 1, wherein the configuration triggering unit is a father wireless unit that is arranged to trigger a change of a wireless unit configuration of at least one son of the father wireless unit.

4. The wireless network according to claim 1, wherein the configuration triggering unit is a wireless unit that is arranged to trigger a change of a wireless unit configuration of the wireless unit.

5. The wireless network according to claim 1, wherein the configuration triggering unit is arranged to trigger the change of at least one wireless unit configuration if it is determined that a number of levels of the wireless network exceeds at least one threshold.

6. The wireless network according to claim 1, wherein the configuration triggering unit is arranged to trigger the change of at least one wireless unit configuration if it is determined that a change in a number of wireless units that belong to the wireless network exceeds a third threshold.

7. The wireless network according to claim 1, wherein the configuration triggering unit is arranged to trigger the change of at least one wireless unit configuration of a wireless unit if it is determined that a value of a communication parameter deviates from a desired value, wherein the communication parameter relates to a communication between the wireless unit and either a son of the wireless unit or a father of the wireless unit.

8. The wireless network according to claim 1, wherein the configuration triggering unit is arranged to trigger the change of at least one wireless unit configuration of a wireless unit if it is determined that a value of a power consumption of at least one wireless unit deviates from a desired value.

9. The wireless network according to claim 1, wherein each father is arranged to allocate, for each son, a son identifier that represents the order of associating each one of the son, father and at least zero higher-hierarchy wireless unit.

10. The wireless network according to claim 1, wherein a plurality of wireless units and at least one father comprise sensors.

11. A method for operating a wireless network, the wireless network comprises a wireless network leader and multiple wireless units; wherein the method comprises:
configuring, at a first point in time, the wireless units, so that each wireless is configured to according to a wireless unit configuration selected out of a group consisting of:
(a) an unauthorized and empty wireless unit that has no sons and is not authorized to have sons,
(b) an authorized and full wireless unit that is connected to a maximal allowable number of sons,
(c) an authorized and not full wireless unit that has less than the maximal allowable number of sons and is authorized to add at least one son, and
(d) an unauthorized and not empty wireless unit that has less than the maximal allowable number of sons and is unauthorized to add at least one son;
transmitting, by at least one wireless unit messages only to a father of the wireless unit or to a son of the wireless unit; wherein each wireless unit has a single father wireless unit, wherein the father wireless unit is selected out of the wireless network leader and the multiple wireless units; and
triggering, by a configuration triggering unit of the wireless network and at a second point in time, a change of at least one wireless unit configuration; wherein the configuration triggering unit is selected out of the wireless network leader and the multiple wireless units.

12. The method according to claim 11, comprising allowing a wireless unit to find one or more sons if it is authorized to do so and only after a father of that wireless unit is defined.

13. The method according to claim 12, comprising allowing wireless units to find sons in a gradual manner.

14. The method according to claim 13, comprising allowing, during a first time window, the wireless network leader to find first level wireless units and define the first level wireless unit as sons; and allowing, during a second time window authorized and non-full first level wireless units to find second level wireless units and define the second level wireless units as sons.
